(19) United States
(12) Patent Application Publication
(10) Pub. No.: US 2026/0243935 A1
(43) Pub. Date: Aug. 20, 2026

(54) OPTICAL FILTER, DETECTION DEVICE, AND OPTICAL LAMINATE

(71) Applicant: NITTO DENKO CORPORATION, Osaka (JP)

(72) Inventors: Masato KATSUDA, Osaka (JP); Yudai NUMATA, Osaka (JP); Shoichi MATSUDA, Osaka (JP)

(73) Assignee: NITTO DENKO CORPORATION, Osaka (JP)

(21) Appl. No.: 19/164,274

(22) PCT Filed: Feb. 19, 2024
(86) PCT No.: PCT/JP2024/005751

§ 371 Date: Sep. 11, 2025

(30) Foreign Application Priority Data
Mar. 13, 2023 (JP) 2023-038401

(51) Int. Cl. G02B 5/20; G01J 1/04

(52) U.S. Cl. CPC G02B 5/208; G01J 1/0488

(57) ABSTRACT

In an optical filter, a BRDF (bidirectional reflectance distribution function) in a case where visible light with a wavelength of 550 nm enters at an incident angle of 0° is 0.1 [1/sr] or greater at angles which are not less than −30° and not more than −5° and angles which are not less than 5° and not more than 30°; and, in a BTDF (bidirectional transmittance distribution function) in a case where infrared light with a wavelength of 850 nm enters at an incident angle of 0°, (a value at −1°)/(a value at −10°) and (a value at 1°)/(a value at 10°) are 30 or smaller.

### TECHNICAL FIELD

The present invention relates to an optical filter, and to a detection device and an optical stack utilizing the same.

### BACKGROUND ART

Infrared-based object detection employs an infrared light source that emits infrared light with which to irradiate an object and an infrared sensor to detect infrared light that is reflected from the object (e.g., Patent Document 1). Due to appearance and decorative concerns, sometimes it is required that the infrared light source and the infrared sensor be hidden so that they will not be visually recognized.

What is to be hidden is not necessarily the infrared light source and the infrared sensor alone. In recent years, AR (Augmented Reality) markers such as bar codes, QR Code (registered trademark), ArUco, Chameleon Code are used in various applications (e.g., Patent Document 2). Appearance and decoration issues may require the AR markers to be hidden so that they are not visually recognizable. It is assumed that AR markers are capable of being read with infrared light.

For the aforementioned hiding purposes, it may be conceivable to use an optical filter containing a black pigment as in Patent Document 3, for example. The black pigment in Patent Document 3 absorbs visible light, and transmits infrared light. Using an optical filter containing this black pigment allows for an infrared-based object detection such that, while hiding the infrared light source and the infrared sensor, an object can be irradiated with infrared light that is emitted from the infrared light source and infrared light that is reflected from the object can be detected with the infrared sensor. Also, this allows AR markers to be read with infrared light while keeping the AR markers hidden.

In the present specification, unless otherwise specified, “infrared light” is meant to include at least light of wavelengths in the range of not less than 780 nm and not greater than 4000 nm. On the other hand, “visible light” is meant to be light of wavelengths in the range of 380 nm or greater but below 780 nm.

### CITATION LIST

### Patent Literature

[Patent Document 1] Japanese National Phase PCT Laid-Open Publication No. 2019-524602
[Patent Document 2] Japanese Laid-Open Patent Publication No. 2016-224485
[Patent Document 3] Japanese Laid-Open Patent Publication No. 2019-207303

### SUMMARY OF INVENTION

### Technical Problem

Because the black pigment in Patent Document 3 absorbs visible light, heat might be generated in the optical filter. Heat generated in the optical filter may unfavorably affect what is to be hidden. Furthermore, the black pigment in Patent Document 3 transmits infrared light with a high linear transmittance; therefore, if an object is detected with infrared light through an optical filter containing this black pigment, glare may occur in a case where the infrared light that is reflected from the object contains a lot of linear reflection component.

The present invention has been made in order to solve the above problem, and an objective thereof is to provide an optical filter which allows for reducing heating that results from absorption of visible light and reducing the glare associated with detecting an object with infrared light, and a detection device and an optical stack utilizing the same.

### Solution to Problem

According to embodiments of the present invention, solutions as recited in the following Items are provided.

### [Item 1]

An optical filter wherein,
a BRDF (bidirectional reflectance distribution function) in a case where visible light with a wavelength of 550 nm enters at an incident angle of 0° is 0.1 [1/sr] or greater at angles which are not less than −30° and not more than −5° and angles which are not less than 5° and not more than 30°; and,
in a BTDF (bidirectional transmittance distribution function) in a case where infrared light with a wavelength of 850 nm enters at an incident angle of 0°, (a value at −1°)/(a value at −10°) and (a value at 1°)/(a value at 10°) are 30 or smaller.
   [Item 2] The optical filter of Item 1, wherein (a value at −1°)/(a value at −10°) and (a value at 1°)/(a value at 10°) are 25 or smaller.
   [Item 3] The optical filter of Item 1 or 2, wherein the BTDF is 50 [1/sr] or smaller at angles which are not less than −5° and not more than 5°.
   [Item 4] The optical filter of any one of Items 1 to 3, wherein a mean value of diffuse transmittances at wavelengths in a range of not less than 800 nm and not more than 2000 nm is 35% or more.
   [Item 5] The optical filter of any one of Items 1 to 4, comprising an optical layer that causes backward scatter of the visible light and causes forward scatter of the infrared light, wherein the optical layer comprises a scattering plane that causes forward scatter of the infrared light.
   [Item 6] The optical filter of Item 5, wherein the scattering plane has a mean roughness Ra of 1 μm or more, and a maximum height Rz of 15 μm or more.
   [Item 7] The optical filter of any one of Items 1 to 4, comprising:
an optical layer that causes backward scatter of the visible light and permits linear transmission of the infrared light; and
a scattering layer that causes forward scatter of the infrared light, the scattering layer being disposed on the optical layer directly or via another layer.
   [Item 8] The optical filter of any one of Items 1 to 7, wherein a mean value of haze values of the optical filter at wavelengths in a range of not less than 800 nm and not more than 2000 nm is 40% or more.
   [Item 9] The optical filter of any one of Items 5 to 7, wherein, as measured by SCE (Specular Component Excluded) method using a spectrocolorimeter, the optical layer has an L* value of 20 or greater.
   [Item 10] The optical filter of any one of Items 5 to 9, wherein the optical layer comprises a matrix and microparticles dispersed in the matrix to serve as light-scattering bodies.
   [Item 11] The optical filter of Item 10, wherein the microparticles create at least a colloidal amorphous aggregate.
   [Item 12] The optical filter of Item 11, wherein a transmittance curve of a visible light wavelength region of the optical layer has a curved segment in which linear transmittance monotonically decreases from longer wavelengths toward shorter wavelengths, the curved segment shifting toward longer wavelengths with an increasing incident angle.
   [Item 13] A detection device that detects an object, the detection device comprising:
an infrared light source to emit infrared light with which to irradiate the object;
an infrared sensor to detect infrared light that is reflected from the object; and
the optical filter of any one of Items 1 to 12, the optical filter being disposed so as to lie across the infrared light emitted from the infrared light source.
   [Item 14] An optical stack comprising:
the optical filter of any one of Items 1 to 12, the optical filter having a first principal face and a second principal face on an opposite side from the first principal face; and
a storage medium layer being disposed on the second principal face side of the optical filter and having a pattern that is readable with the infrared light through the optical filter.

### Advantageous Effects of Invention

According to embodiments of the present invention, an optical filter which allows for reducing heating that results from absorption of visible light and reducing the glare associated with detecting an object with infrared light, and a detection device and an optical stack utilizing the same are provided.

### BRIEF DESCRIPTION OF DRAWINGS

FIG. 1A A schematic cross-sectional view of a detection device according to an illustrative embodiment of the present invention.

FIG. 1B Another schematic cross-sectional view of the detection device according to an illustrative embodiment of the present invention.

FIG. 2A A schematic cross-sectional view of an optical stack according to an illustrative embodiment of the present invention.

FIG. 2B Another schematic cross-sectional view of the optical stack according to an illustrative embodiment of the present invention.

FIG. 3A A schematic cross-sectional view of an optical filter according to an illustrative embodiment of the present invention.

FIG. 3B A schematic cross-sectional view of an optical filter according to another illustrative embodiment of the present invention.

FIG. 3C A schematic cross-sectional view of an optical filter according to still another embodiment of the present invention.

FIG. 3D A schematic cross-sectional view of an optical filter according to still another embodiment of the present invention.

FIG. 4 A schematic cross-sectional view of the interior of an optical layer included in an optical filter.

FIG. 5 A cross-sectional TEM image of a visible light scattering layer.

FIG. 6 A graph that is normalized by maximum transmittance, showing incident angle dependence of a linear transmittance spectrum of the visible light scattering layer.

FIG. 7A A schematic diagram showing an example of a decoration of continuous patterning.

FIG. 7B A schematic diagram showing another example of a decoration of continuous patterning.

FIG. 7C A schematic diagram showing an example of tile-like decoration.

FIG. 7D A schematic diagram showing another example of tile-like decoration.

FIG. 8A A schematic cross-sectional view for describing a measurement method of BRDF.

FIG. 8B A schematic cross-sectional view for describing a measurement method of BRDF.

FIG. 9A A cross-sectional TEM image of an optical filter of Example 3.

FIG. 9B A cross-sectional TEM image of an optical filter of Example 6.

FIG. 10A BRDF of optical filters of Comparative Examples 1 to 4 in a case where visible light with a wavelength of 550 nm enters at an incident angle of 0°.

FIG. 10B BTDF of the optical filters of Comparative Examples 1 to 4 in a case where visible light with a wavelength of 550 nm enters at an incident angle of 0°.

FIG. 10C BRDF of the optical filters of Comparative Examples 1 to 4 in a case where infrared light with a wavelength of 850 nm enters at an incident angle of 0°.

FIG. 10D BTDF of the optical filters of Comparative Examples 1 to 4 in a case where infrared light with a wavelength of 850 nm enters at an incident angle of 0°.

FIG. 11A BRDF of the optical filters of Examples 1 and 2 in a case where visible light with a wavelength of 550 nm enters at an incident angle of 0°.

FIG. 11B BTDF of optical filters of Examples 1 and 2 in a case where visible light with a wavelength of 550 nm enters at an incident angle of 0°.

FIG. 11C BRDF of the optical filters of Examples 1 and 2 in a case where infrared light with a wavelength of 850 nm enters at an incident angle of 0°.

FIG. 11D BTDF of the optical filters of Examples 1 and 2 in a case where infrared light with a wavelength of 850 nm enters at an incident angle of 0°.

FIG. 12A BRDF of optical filters of Examples 3 to 6 in a case where visible light with a wavelength of 550 nm enters at an incident angle of 0°.

FIG. 12B BTDF of the optical filters of Examples 3 to 6 in a case where visible light with a wavelength of 550 nm enters at an incident angle of 0°.

FIG. 12C BRDF of the optical filters of Examples 3 to 6 in a case where infrared light with a wavelength of 850 nm enters at an incident angle of 0°.

FIG. 12D BTDF of the optical filters of Examples 3 to 6 in a case where infrared light with a wavelength of 850 nm enters at an incident angle of 0°.

### DESCRIPTION OF EMBODIMENTS

### Embodiments

Hereinafter, with reference to the drawings, a detection device and an optical stack utilizing an optical filter according to an embodiment of the present invention will be first described, then followed by a detailed description of the structure of the optical filter according to an embodiment of the present invention. Finally, Examples of the optical filter will be described. Optical filters according to embodiments of the present invention and detection devices and optical stacks according to embodiments of the present invention are not limited to what is illustrated below.

In an optical filter according to an embodiment of the present invention, a BRDF (bidirectional reflectance distribution function) in a case where visible light with a wavelength of 550 nm enters at an incident angle of 0° is 0.1 [1/sr] or greater at angles which are not less than −30° and not more than −5° and angles which are not less than 5° and not more than 30°; and, in a BTDF (bidirectional transmittance distribution function) in a case where infrared light with a wavelength of 850 nm enters at an incident angle of 0°, (a value at −1°)/(a value at −10°) and (a value at 1°)/(a value at 10°) are 30 or smaller.

With the optical filter according to an embodiment of the present invention, it is possible to reduce heating that results from absorption of visible light and reduce the glare associated with detecting an object with infrared light.

A detection device according to an embodiment of the present invention that detects an object includes: an infrared light source to emit infrared light with which to irradiate the object; an infrared sensor to detect infrared light that is reflected from the object; and the aforementioned optical filter being disposed so as to lie across the infrared light emitted from the infrared light source.

With the photodetection device according to an embodiment of the present invention, the optical filter allows for reducing the possibility that the infrared light source and the infrared sensor may be visually recognized.

An optical stack according to an embodiment of the present invention includes: the aforementioned optical filter having a first principal face and a second principal face on an opposite side from the first principal face; and a storage medium layer being disposed on the second principal face side of the optical filter and having a pattern that is readable with the infrared light through the optical filter.

With the optical stack according to an embodiment of the present invention, the optical filter allows for reducing the possibility that the pattern of the storage medium layer may be visually recognized.

### [Detection Device]

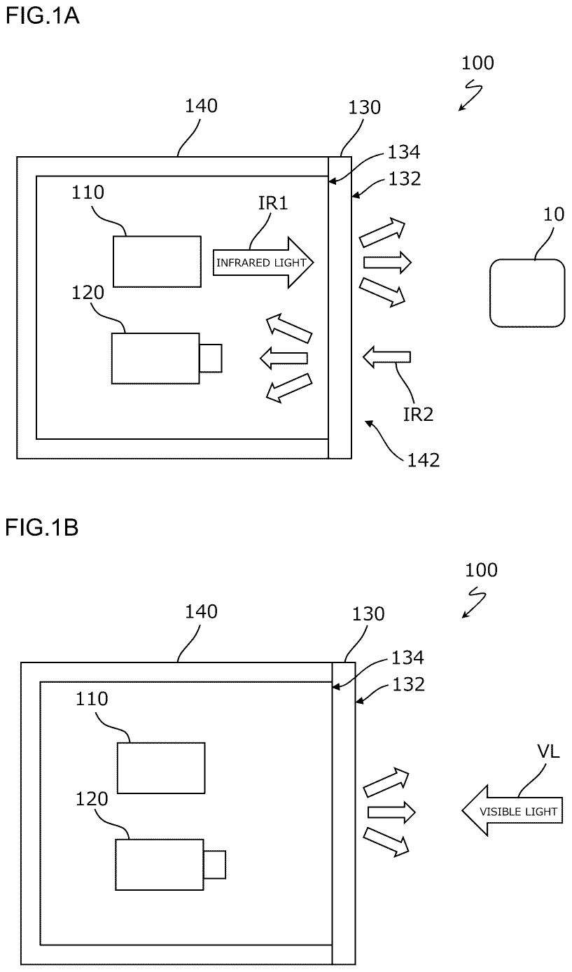

First, with reference to FIG. 1A and FIG. 1B, an example configuration for a detection device utilizing an optical filter according to an embodiment of the present invention will be described.

FIG. 1A shows a schematic cross-sectional view of a detection device according to an illustrative embodiment of the present invention. FIG. 1A also shows an object 10 to be detected. The object 10 may be any arbitrary object, e.g., a person, or a product that is carried by a conveyor belt. The detection device 100 shown in FIG. 1A includes an infrared light source 110, an infrared sensor 120, an optical filter 130, and a housing 140 accommodating the infrared light source 110 and the infrared sensor 120.

The infrared light source 110 may be an infrared lamp or an infrared LED that emits infrared light, for example. The infrared sensor 120 may be an image sensor that acquires an infrared image, for example. The optical filter 130 has a first principal face 132 and a second principal face 134 on the opposite side therefrom. The optical filter 130 causes forward scatter of infrared light that is incident on the first principal face 132 or the second principal face 134, and backward scatter of visible light that is incident on the first principal face 132 or the second principal face 134. A detailed structure of the optical filter 130 and evaluations of scattering characteristics based on BRDF and BTDF will be described later. The object 10 is located on the first principal face 132 side of the optical filter 130, whereas the infrared light source 110 and the infrared sensor 120 are disposed on the second principal face 134 side of the optical filter 130. The housing 140 has a box shape with one open face, with the optical filter 130 closing its open opening 142.

Note that the housing 140 is not an essential component element of the detection device 100. For example, in a case where the detection device 100 is disposed as part of the ceiling, the walls, or the floor, i.e., when the infrared light source 110 and the infrared sensor 120 are provided inside the ceiling, the walls, or the floor, such that the optical filter 130 covers these, the detection device 100 does not need the housing 140.

In the detection device 100 according to an embodiment of the present invention, the object 10 is detected as follows. The infrared light source 110 emits infrared light IR1 with which to irradiate the object 10 via the optical filter 130. The wavelength of the infrared light IR1 is not less than 780 nm and not greater than 4000 nm, and may preferably be not less than 780 nm and not greater than 2500 nm, for example. Via the optical filter 130, the infrared sensor 120 detects infrared light IR2 that is reflected from the object 10. The optical filter 130 is disposed so as to lie across the infrared light IR1 emitted from the infrared light source 110. The optical filter 130 causes forward scatter of the infrared light IR1 being incident on the second principal face 134, such that the forward-scattered infrared light IR1 is incident on the object 10. Furthermore, the optical filter 130 causes forward scatter of the infrared light IR2 being reflected from the object 10 and incident on the first principal face 132, such that the forward-scattered infrared light IR2 is incident on the infrared sensor 120.

Unlike in the detection device 100 according to an embodiment of the present invention, in a configuration using an optical filter that permits linear transmission of infrared light, any infrared light that is emitted from the infrared light source 110 and incident on the infrared sensor 120 via the object 10 contains a lot of linear reflection component from the object 10. Therefore, such infrared light being detected may cause a glare associated with the linear reflection component from the object 10, possibly preventing clear detection of the object 10.

On the other hand, in the detection device 100 according to an embodiment of the present invention, any infrared light that is emitted from the infrared light source 110 and incident on the infrared sensor 120 via the object 10 undergoes two instances of forward scatter at the optical filter 130. Because the object 10 is irradiated with the forward-scattered infrared light IR1, the linear reflection component from the object 10 can be reduced. In addition, because the infrared light IR2 being reflected from the object 10 and then forward-scattered is detected, the linear reflection component from the object 10 can be further reduced. As a result, the glare associated with detecting the object 10 with the infrared light IR1 can be effectively reduced, thus allowing the object 10 to be more clearly detected. In the detection of the object 10 with the detection device 100, the distance from the detection device 100 to the object 10 may be measured by using a time-of-flight method.

FIG. 1B shows another schematic cross-sectional view of the detection device 100 according to the illustrative embodiment of the present invention. The optical filter 130 causes backward scatter of visible light VL being incident on the first principal face 132. Backward scatter by the optical filter 130 can reduce the amount of visible light VL reaching the infrared light source 110 and the infrared sensor 120. Even if a portion of the visible light VL is incident on the infrared light source 110 and the infrared sensor 120, the visible light being reflected by the infrared light source 110 and infrared sensor 120 and being incident on the second principal face 134 is backward-scattered by the optical filter 130. This allows for reducing the possibility that the infrared light source 110 and the infrared sensor 120 may be visually recognized from the first principal face 132 side of the optical filter 130. When the object 10 shown in FIG. 1A is a person, this effectively makes it less likely for the person's behavior and action to be affected by any phycological changes associated with the infrared light source 110 and the infrared sensor 120 being visually recognizable.

Unlike in the detection device 100 according to an embodiment of the present invention, in a configuration using an optical filter that absorbs visible light, heat may be generated in the optical filter. The heat generated in the optical filter may unfavorably affect the infrared light source 110 and the infrared sensor 120. On the other hand, in the detection device 100 according to an embodiment of the present invention, the optical filter 130 causes backward scatter of the visible light VL, thereby reducing the heating associated with absorption of visible light VL.

As will be described in detail below, the optical filter 130 includes an optical layer which presents a white color, rather than a multilayer film of dielectric having a mirror-like appearance. As measured by SCE method on a CIE1976 color space, the optical layer has an L* value of 20 or greater.

The optical layer exhibiting a white color allows for reducing the possibility that the infrared light source 110 and the infrared sensor 120 may be visually recognized from the outside, and provides an improved decorative freedom for the detection device 100. When decoration is added to the mirror-like surface, the decoration may be less conspicuous than the mirror-like background. On the other hand, when decoration is added to a surface exhibiting a white color, the decoration can become more outstanding than the white background. In the present specification, “decoration” means any patterning and/or coloration on an item. Patterning includes pictorial designs or graphic designs. Coloration may be in a single color, and may include a combination of colors of the same hue but different chromas. The coloration, pictorial design, or graphic design may be in tile-like form.

Thus, with the detection device 100 according to the present embodiment, the optical filter 130 allows for reducing the possibility that the infrared light source 110 and the infrared sensor 120 may be visually recognized. Furthermore, heating of the optical filter 130 associated with absorption of visible light VL can be reduced, while also reducing the glare associated with detecting the object 10 with the infrared light IR1.

Note that a configuration obtained by eliminating the infrared sensor 120 from the detection device 100 may be utilized as a light source device. Based on such a light source device, the object 10 is irradiated with the forward-scattered infrared light IR1, whereby the linear reflection component from the object 10 can be reduced. Alternatively, a configuration obtained by eliminating the infrared light source 110 from the detection device 100 may be utilized as a sensor device. Based on such a sensor device, the infrared light IR2 being reflected from the object 10 and then forward-scattered is detected, whereby the linear reflection component from the object 10 can be reduced. The light source device and sensor device will be useful in clearly detecting the object 10 with infrared light.

### [Optical Stack]

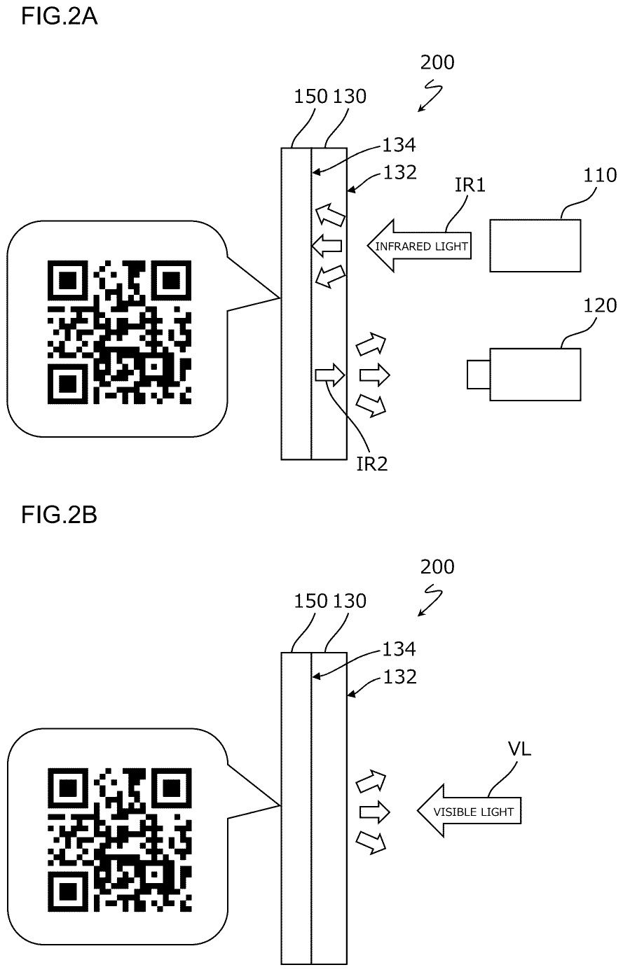

What is to be hidden is not limited to the infrared light source 110 and the infrared sensor 120. Next, with reference to FIG. 2A and FIG. 2B, an example configuration for an optical stack utilizing an optical filter according to an embodiment of the present invention will be described.

FIG. 2A shows a schematic cross-sectional view of an optical stack according to an illustrative embodiment of the present invention. The optical stack 200 shown in FIG. 2A includes: the aforementioned optical filter 130; and a storage medium layer 150 that has a pattern which is readable with infrared light via the optical filter 130. FIG. 2A also shows an infrared light source 110 and an infrared sensor 120 that are used in reading the pattern on the storage medium layer 150. The infrared light source 110 and the infrared sensor 120 are located on the first principal face 132 side of the optical filter 130, and the storage medium layer 150 is disposed on the second principal face 134 side of the optical filter 130. In the example shown in FIG. 2A, the pattern on the storage medium layer 150 is a QR Code, which is a kind of AR marker. The pattern on the storage medium layer 150 may be an information-containing pattern such as an AR marker, or otherwise be any generic decoration. The optical stack 200 may be disposed as part of the ceiling, the walls, or the floor, for example.

In the optical stack 200 according to an embodiment of the present invention, the pattern on the storage medium layer 150 is read in the following manner. The infrared light source 110 emits infrared light IR1 with which to irradiate the pattern on the storage medium layer 150 via the optical filter 130. Via the optical filter 130, the infrared sensor 120 detects infrared light IR2 that is reflected from the storage medium layer 150. The optical filter 130 causes forward scatter of the infrared light IR1 being incident on the first principal face 132. The forward-scattered infrared light IR1 is incident on the storage medium layer 150. Furthermore, the optical filter 130 causes forward scatter of the infrared light IR2 being reflected from the storage medium layer 150 and incident on the second principal face 134. The forward-scattered infrared light IR2 is incident on the infrared sensor 120.

Unlike in the optical stack 200 according to an embodiment of the present invention, in a configuration using an optical filter that permits linear transmission of infrared light, any infrared light that is emitted from the infrared light source 110 and incident on the infrared sensor 120 via the storage medium layer 150 contains a lot of linear reflection component from the storage medium layer 150. Therefore, such infrared light being detected may cause a glare associated with the linear reflection component from the storage medium layer 150, possibly preventing clear detection of the pattern on the storage medium layer 150.

On the other hand, in the optical stack 200 according to an embodiment of the present invention, any infrared light that is emitted from the infrared light source 110 and incident on the infrared sensor 120 via the storage medium layer 150 undergoes two instances of forward scatter at the optical filter 130, whereby the linear reflection component from the storage medium layer 150 can be effectively reduced. As a result, the glare associated with detecting the pattern on the storage medium layer 150 with the infrared light IR1 can be reduced, and it becomes possible to more clearly detect the pattern on the storage medium layer 150.

FIG. 2B shows another schematic cross-sectional view of the optical stack according to the illustrative embodiment of the present invention. The optical filter 130 causes backward scatter of visible light VL being incident on the first principal face 132. Backward scatter by the optical filter 130 can reduce the amount of visible light VL reaching the storage medium layer 150. Even if a portion of the visible light VL is incident on the storage medium layer 150, the visible light reflected from the storage medium layer 150 is backward-scattered by the optical filter 130. This allows for reducing the possibility that the storage medium layer 150 may be visually recognized from the first principal face 132 side of the optical filter 130.

Unlike in the optical stack 200 according to an embodiment of the present invention, in a configuration using an optical filter that absorbs visible light, heat may be generated in the optical filter. The heat generated in the optical filter may unfavorably affect the pattern on the storage medium layer 150. On the other hand, in the optical stack 200 according to an embodiment of the present invention, the optical filter 130 causes backward scatter of the visible light VL, thereby reducing the heating associated with absorption of visible light VL.

As mentioned above, the optical filter 130 includes an optical layer exhibiting a white color. The optical layer exhibiting a white color allows for reducing the possibility that the pattern on the storage medium layer 150 may be visually recognized from the outside, and provides an improved decorative freedom for the optical stack 200.

As described above, with the optical stack 200 according to the present embodiment, the optical filter 130 allows for reducing the possibility that the pattern on the storage medium layer 150 may be visually recognized. Furthermore, heating of the optical filter 130 associated with absorption of visible light VL can be reduced, and the glare associated with detecting the pattern on the storage medium layer 150 with the infrared light IR1 can be reduced.

Note that what is to be hidden of the optical filter 130 may any arbitrary object, without being limited to the infrared light source 110 and the infrared sensor 120 included in the detection device 100 and the pattern on the storage medium layer 150 included in the optical stack 200.

### [Structure of Optical Filter]

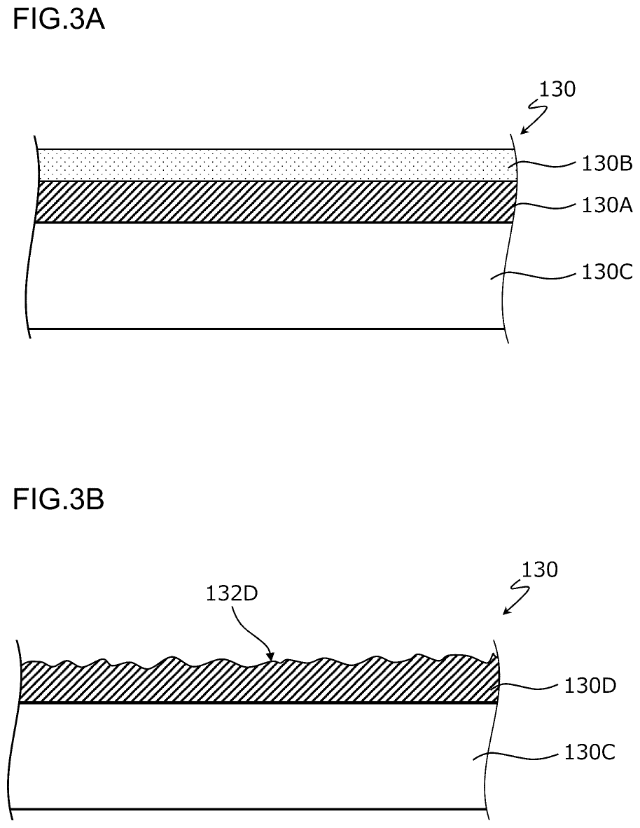

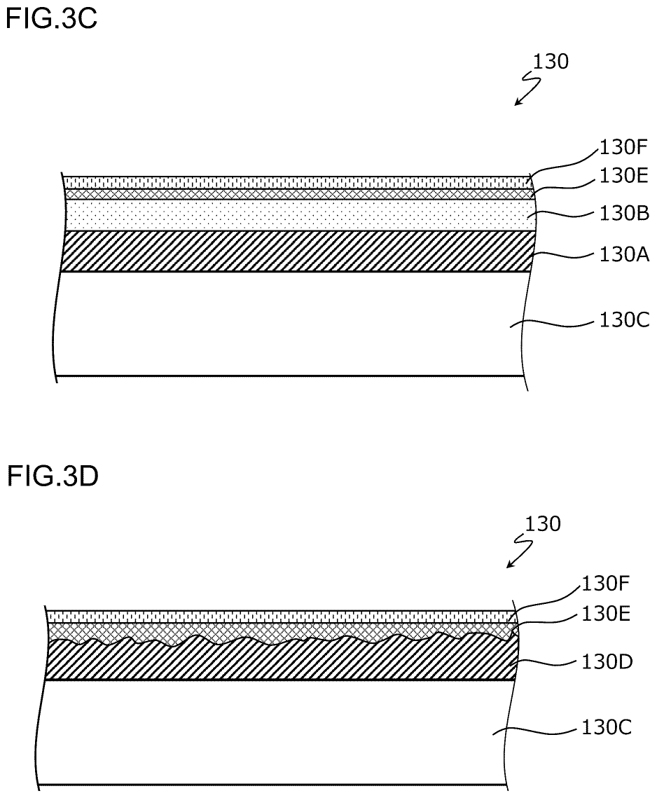

Next, with reference to FIG. 3A to FIG. 3D, the structure of an optical filter according to an embodiment of the present invention will be described in detail.

FIG. 3A shows a schematic cross-sectional view of an optical filter according to an illustrative embodiment of the present invention. The optical filter 130 shown in FIG. 3A includes: an optical layer 130A that causes backward scatter of visible light and permits linear transmission of infrared light; a scattering layer 130B that is disposed on the optical layer 130A and causes forward scatter of infrared light; and a base layer 130C supporting the optical layer 130A. The scattering layer 130B does not need to cause forward scatter or backward scatter of visible light. The scattering layer 130B may be disposed directly on the optical layer 130A, or disposed via another layer on the optical layer 130A. The scattering layer 130B may be an anti-glare layer or a layer that is made of a tackiness agent containing a scattering component, for example. The haze value of the optical filter 130 shown in FIG. 3A with respect to infrared light is e.g. 40% or more, and may more preferably be 60% or more. Herein, a haze value with respect to infrared light is a mean value of haze values at wavelengths of not less than 800 nm and not more than 2000 nm.

In the optical filter 130 shown in FIG. 3A, the first principal face 132 shown in FIG. 1A to FIG. 2B is an opposite surface of the scattering layer 130B from the optical layer 130A, and the second principal face 134 is an opposite surface of the base layer 130C from the optical layer 130A. The first principal face 132 and the second principal face 134 may be reversed.

In the optical filter 130 shown in FIG. 3A, infrared light that is incident from the scattering layer 130B side is forward-scattered by the scattering layer 130B, and is transmitted through the optical layer 130A and the base layer 130C in this order. Infrared light that is incident from the base layer 130C side is transmitted through the base layer 130C and the optical layer 130A in this order, and is forward-scattered by the scattering layer 130B. Visible light that is incident from the scattering layer 130B side is transmitted through the scattering layer 130B, backward-scattered by the optical layer 130A, and again transmitted through the scattering layer 130B. Visible light that is incident from the base layer 130C side is transmitted through the base layer 130C, backward-scattered by the optical layer 130A, and again transmitted through the base layer 130C. In this manner, the optical filter 130 shown in FIG. 3A causes backward scatter of visible light, and causes forward scatter of infrared light.

FIG. 3B shows a schematic cross-sectional view of an optical filter according to another illustrative embodiment of the present invention. The optical filter 130 shown in FIG. 3B includes: an optical layer 130D that causes backward scatter of visible light and causes forward scatter of infrared light; and a base layer 130C supporting the optical layer 130D. The optical layer 130D includes a scattering plane 132D that causes forward scatter of infrared light. The scattering plane 132D does not need to cause forward scatter or backward scatter of visible light. Unlike the optical layer 130D, an optical layer that has a flat surface rather than the scattering plane 132D would correspond to the optical layer 130A shown in FIG. 3A, which causes backward scatter of visible light and permits linear transmission of infrared light. The scattering plane 132D may be formed by transferring the concavo-convex shapes of a rugged member to, or sandblasting, a flat surface of the optical layer 130A, for example. The scattering plane 132D may have a mean roughness Ra of e.g. 1 μm or more, and a maximum height Rz of e.g. 15 μm or more. The haze value of the optical filter 130 shown in FIG. 3B with respect to infrared light is e.g. 40% or more, and may more preferably be 60% or more, and still more preferably be 80% or more. Herein, a haze value with respect to infrared light is a mean value of haze values at wavelengths of not less than 800 nm and not more than 2000 nm.

In the optical filter 130 shown in FIG. 3B, the first principal face 132 shown in FIG. 1A to FIG. 2B is the scattering plane 132D of the optical layer 130D, and the second principal face 134 is an opposite surface of the base layer 130C from the optical layer 130D. The first principal face 132 and the second principal face 134 may be reversed.

In the optical filter 130 shown in FIG. 3B, infrared light that is incident from the optical layer 130D side is forward-scattered by the scattering plane 132D, and transmitted through the optical layer 130D and the base layer 130C in this order. Infrared light that is incident from the base layer 130C side is transmitted through the base layer 130C and the optical layer 130D in this order, and forward-scattered by the scattering plane 132D. Visible light that is incident from the optical layer 130D side is backward-scattered by the optical layer 130D. Visible light that is incident from the base layer 130C side is transmitted through the base layer 130C, backward-scattered by the optical layer 130D, and again transmitted through the base layer 130C. In this manner, the optical filter 130 shown in FIG. 3B causes backward scatter of visible light, and causes forward scatter of infrared light.

Usually, a scattering layer or a scattering plane causes forward scatter or backward scatter of visible light in order to reduce the glare upon visual recognition. On the other hand, the scattering layer 130B or the scattering plane 132D included in the optical filter 130 according to an embodiment of the present invention causes forward scatter of infrared light. An optical filter 130 according to an embodiment of the present invention is superior to an optical filter that permits linear transmission of infrared light in that the scattering layer 130B or the scattering plane 132D allows for reducing the glare associated with detecting the object 10 or the pattern on the storage medium layer 150 with the infrared light IR1.

The optical filter 130 according to an embodiment of the present invention may further include another layer. FIG. 3C and FIG. 3D show schematic cross-sectional views of an optical filter according to still another embodiment of the present invention. The optical filter 130 shown in FIG. 3C includes a decorative layer 130E disposed on the scattering layer 130B, in addition to the optical layer 130A, the scattering layer 130B, and the base layer 130C shown in FIG. 3A. The optical filter 130 shown in FIG. 3D includes a decorative layer 130E disposed on the optical layer 130D, in addition to the optical layer 130D and the base layer 130C shown in FIG. 3B.

Preferably, the decorative layer 130E has a high infrared light transmittance. The decorative layer 130E may be in film form, e.g., a decorative film, or may not be in film form. The thickness of the decorative layer 130E is e.g. not less than 1 μm and not more than 150 μm. In the present specification, when a surface of a layer is not flat, the largest thickness of the layer is to be regarded as the thickness of the layer.

The optical filter 130 according to an embodiment of the present invention may further include another functional layer exhibiting a specific function. In that case, a single functional layer may exhibit two or more functions, or another function may be conferred to at least one of the aforementioned layers. Although the functions to be conferred to the optical filter 130 are not particularly limited, as shown in FIG. 3C and FIG. 3D, the optical filter 130 according to an embodiment of the present invention further includes a surface protection layer 130F disposed on the decorative layer 130E. The surface protection layer 130F is configured to exhibit a hard coating (HC) function that provides scratch resistance, a soil resistance function, an anti-glare (Anti-Glare) function, an anti-reflection (AR) function, or the like, for example.

In the optical filter 130 shown in FIG. 3C and FIG. 3D, the first principal face 132 shown in FIG. 1A to FIG. 2B is an opposite surface of the surface protection layer 130F from the decorative layer 130E, and the second principal face 134 is an opposite surface of the base layer 130C from the optical layer 130A or 130D.

The optical filter 130 according to an embodiment of the present invention also functions as a cover for the detection device 100 and the optical stack 200. The base layer 130C included in the optical filter 130 has the mechanical strength of a cover, and has high infrared light transmittance. The base layer 130C may be made of a transparent plastic, e.g., an acrylic resin, for example. The base layer 130C may include a multilayer dielectric film having a mirror-like appearance, in order to achieve an improved ability to suppress visibility with respect to visible light. The thickness of the base layer 130C is e.g. not less than about 2 μm and not more than about 10 mm.

The optical layer 130A, 130D included in the optical filter 130 according to an embodiment of the present invention presents a white color. Herein, a white color refers to those whose x, y coordinates are within the respective ranges of 0.25≤x≤0.40, 0.25≤y≤0.40 on the CIE1931 chromaticity diagram, given D65 light source as standard illuminants. It will be appreciated that the closer to x=0.333, y=0.333, the higher whiteness is achieved; preferably 0.28≤x≤0.37, 0.28≤y≤0.37, and more preferably 0.30≤x≤0.35, 0.30≤y≤0.35. Also, an L* as measured by SCE method on the CIE1976 color space is preferably 20 or greater, more preferably 40 or greater, still more preferably 50 or greater, and particularly more preferably 60 or greater. Anything with an L* of 20 or greater can be generally considered as a white color. The upper limit value for L* is 100, for example. For instance, measurements by SCE method can be taken by using a spectrocolorimeter CM-2600-D (manufactured by Konica Minolta Japan, Inc.).

The L* value of the optical layer 130A, 130D can be adjusted by varying the thickness of the optical layer 130A, 130D. The greater the thickness of the optical layer 130A, 130D is, the greater the L* value of the optical layer 130A, 130D is.

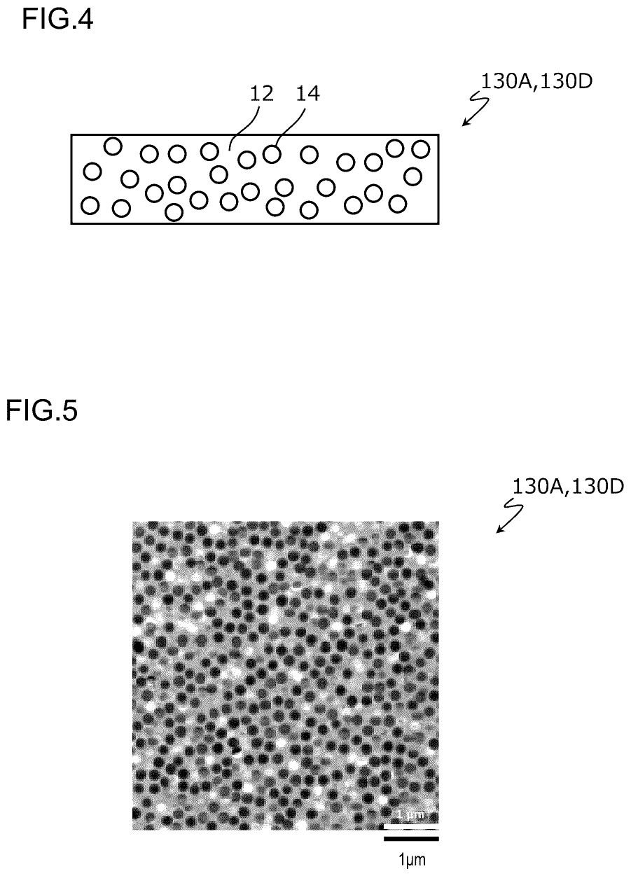

FIG. 4 shows a schematic cross-sectional view of the interior of the optical layer 130A, 130D included in the optical filter 130. The optical layer 130A, 130D includes a matrix 12 and microparticles 14 being dispersed in the matrix 12 to serve as light-scattering bodies. The microparticles 14 behave as light-scattering bodies. The microparticles 14 may create at least a colloidal amorphous aggregate, for example. Any other microparticles may also be contained that do not disturb the colloidal amorphous aggregate created by the microparticles 14.

The optical layer 130A, 130D does not contain any cholesteric liquid crystal (which broadly encompasses high molecular weight liquid crystal, low molecular weight liquid crystal, liquid crystal mixtures thereof, and those which are obtained by mixing a cross-linking agent in these liquid crystal materials and setting them via cross-linking or the like and which exhibit a cholesteric phase). The optical layer 130A, 130D may schematically be in film form, for example, but is not limited thereto.

Transparent microparticles 14 are silica microparticles, for example. As silica microparticles, silica microparticles which are synthesized by the Stöber method can be used, for example. As the microparticles, inorganic microparticles other than silica microparticles may be used, and resin microparticles may be used. As resin microparticles, for example, microparticles composed of at least one of polystyrene and polymethyl methacrylate are preferable; and microparticles of cross-linked polystyrene, cross-linked polymethyl methacrylate, or a cross-linked styrene-methyl methacrylate copolymer are more preferable. As such microparticles, for example, polystyrene microparticles or polymethyl methacrylate microparticles which are synthesized through emulsion polymerization can be used as appropriate. Moreover, hollow silica microparticles and hollow resin microparticles containing air can also be used. Note that microparticles made of an inorganic material have the advantages of good thermal resistance and light resistance. The volume fraction of the microparticles relative to the whole (i.e., including the matrix and the microparticles) is preferably not less than 6% and not more than 60%, more preferably not less than 20% and not more than 50%, and still more preferably not less than 20% and not more than 40%. Transparent microparticles 14 may be optically isotropic.

Without limitation, the matrix 12 may be acrylic resins (e.g., polymethyl methacrylate, polymethyl acrylate), polycarbonates, polyesters, poly(diethylene glycol bisallyl carbonate), polyurethanes, epoxy resins, or polyimides, for example. The matrix 12 is preferably formed by using a curable resin (thermosetting or photocurable), and, from the mass producibility standpoint, it is preferably formed by using a photocurable resin. As the photocurable resin, various (meth)acrylates can be used. Preferably, (meth)acrylate contains a bifunctional, trifunctional or greater (meth)acrylate. Moreover, the matrix 12 is preferably optically isotropic. When a curable resin containing a polyfunctional monomer is used, a matrix 12 having a cross-linked structure is obtained, whereby thermal resistance and light resistance can be improved.

The optical layer 130A, 130D whose matrix 12 is made of a resin material may be in the form of a film with softness. The thickness of the optical layer 130A, 130D is e.g. not less than 10 μm and not more than 10 mm. When the thickness of the optical layer 130A, 130D is e.g. not less than 10 μm and not more than 1 mm, and, better yet, not less than 10 μm and not more than 500 μm, remarkable softness will be exhibited.

In the case where silica microparticles with a hydrophilic surface are used as the microparticles, it is preferable to form them by photocuring a hydrophilic monomer, for example. Without limitations, examples of hydrophilic monomers include polyethylene glycol (meth)acrylate, polyethylene glycol di(meth)acrylate, polyethylene glycol tri(meth)acrylate, polypropylene glycol (meth)acrylate, polypropylene glycol di(meth)acrylate, polypropylene glycol tri(meth)acrylate, and 2-hydroxyethyl (meth)acrylate, or 2-hydropropyl (meth)acrylate, acrylamides, methylenebisacrylamide, and Bisphenol A ethoxylate di(meth)acrylate. Each of these monomers may be used alone, or two or more of them may be mixed in use. It will be appreciated that the two or more kinds of monomers may contain a monofunctional monomer and a polyfunctional monomer, or contain two or more kinds of polyfunctional monomers.

A curing reaction of these monomers can be effected by using a photopolymerization initiator as appropriate. Examples of photopolymerization initiators include: carbonyl compounds, such as benzoin ether, benzophenone, anthraquinones, thioxanes, ketal, and acetophenone; sulfur compounds such as disulfides and dithiocarbamates; organic peroxides such as benzoyl peroxide; azo compounds; transition metal complexes; polysilane compounds; dye sensitizers; and the like. They are preferably added in amounts of not less than 0.05 mass parts and not more than 3 mass parts, and more preferably not less than 0.05 mass parts and not more than 1 mass parts, with respect to 100 mass parts of a mixture of the microparticles and the monomer(s).

Given a refractive index n_{M} of the matrix with respect to visible light, and a refractive index n_{P} of the microparticles, |n_{M}−n_{P}| (which hereinafter may be simply referred to as a refractive index difference) is preferably 0.01 or greater, preferably 0.6 or smaller, more preferably 0.03 or greater, and more preferably 0.11 or smaller. When the refractive index difference is smaller than 0.03, there will be weak scattering intensity, so that desired optical characteristics may be difficult to obtain. When the refractive index difference is greater than 0.11, the linear transmittance of infrared light may become lower. Moreover by using zirconium oxide microparticles (refractive index 2.13) and acrylic resin, for example, if a refractive index difference of 0.6 is chosen, adopting a smaller thickness will allow for adjustments of the linear transmittance of infrared light. Thus, the linear transmittance of infrared light can be adjusted by controlling the thickness of the visible light scattering layer and the refractive index difference, for example. Moreover, depending on the application, a filter that absorbs infrared light may also be used in an overlay fashion. Note that a refractive index with respect to light of 546 nm may be used as a typical refractive index for visible light, for example. Herein, unless otherwise specified, any refractive index refers to a refractive index with respect to light of 546 nm.

FIG. 5 shows a cross-sectional TEM image of the optical layer 130A, 130D. In the illustrated TEM image, white circles are silica microparticles, and dark circle are sites where silica microparticles were once present. As shown by the cross-sectional TEM image of the optical layer 130A, 130D, the silica microparticles are dispersed essentially uniformly.

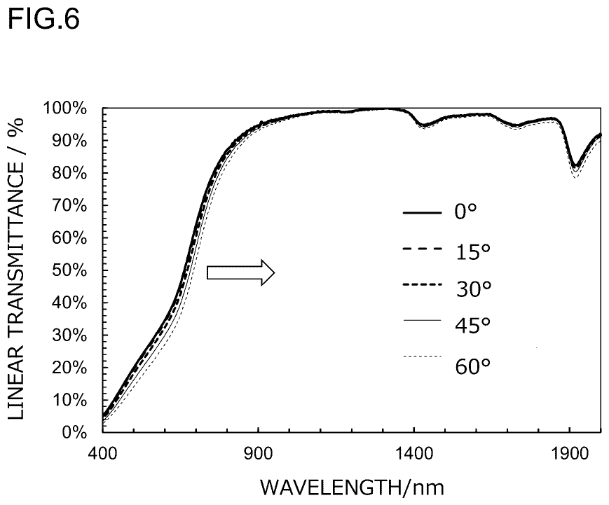

FIG. 6 is a graph that is normalized by maximum transmittance, showing incident angle dependence of a linear transmittance spectrum of the optical layer 130A, 130D. In the transmittance curve of the optical layer 130A, 130D shown in FIG. 6, a curved segment in which the linear transmittance monotonically increases from visible light to infrared light is shifted (by about 50 nm) toward longer wavelengths with an increasing incident angle. In other words, a curved segment in which the linear transmittance monotonically decreases from infrared light to visible light is shifted toward longer wavelengths with an increasing incident angle. This characteristic incident angle dependence is ascribable to a colloidal amorphous aggregate being created by the silica microparticles contained in the optical film. Note that the structure and optical characteristics of the optical layer 130A, 130D and their detailed production method are described in International Application PCT/JP2021/010413 by the applicant. The entire disclosure of International Application PCT/JP2021/010413 is incorporated herein by reference.

The optical layer 130A, 130D is not limited to a layer in which microparticles 14 to serve as light-scattering bodies are dispersed in the matrix 12. The optical layer 130A, 130D may be a fluoroplastic film, for example. Examples of fluoroplastics include PTFE (polytetrafluorethylene), PFA (perfluoroalkoxyalkane), FEP (perfluoroethylene propylene copolymer), ETFE (ethylene tetrafluoroethylene copolymer), PVDF (polyvinylidene fluoride), PCTFE (polychlorotrifluoroethylene), ECTFE (ethylene chlorotrifluoroethylene copolymer), Cytop (manufactured by AGC Inc.). Moreover, the fluoroplastic may compose a foam. For an improved mechanical strength, a glass cloth may be impregnated with the resin. The thickness of the optical layer 130A, 130D is e.g. not less than 10 μm and not more than 10 mm.

### (Example Decorations to be Added to the Optical Filter 130)

Example decorations to be added to the optical filter 130 will now be described, with respect to a configuration in which the detection device 100 or the optical stack 200 is disposed as part of the ceiling, the walls, or the floor. Let a decoration on a surface of the surroundings of a place where the detection device 100 or the optical stack 200 is disposed be called a surrounding decoration, and a decoration on a surface of the optical filter 130 be called a filter decoration; then, the filter decoration is to be identical or similar to the surrounding decoration. The filter decoration and the surrounding decoration may have the same patterning and/or coloration. For example, by using a decorative film, a decoration of patterning and/or coloration can be added to the surface of the optical filter 130 and the surface of the surroundings. The aforementioned surface protection layer may be provided on the surface of the surroundings.

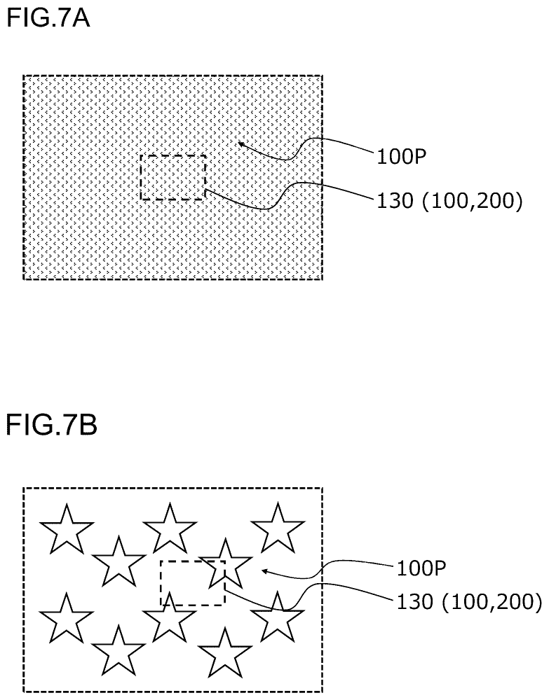

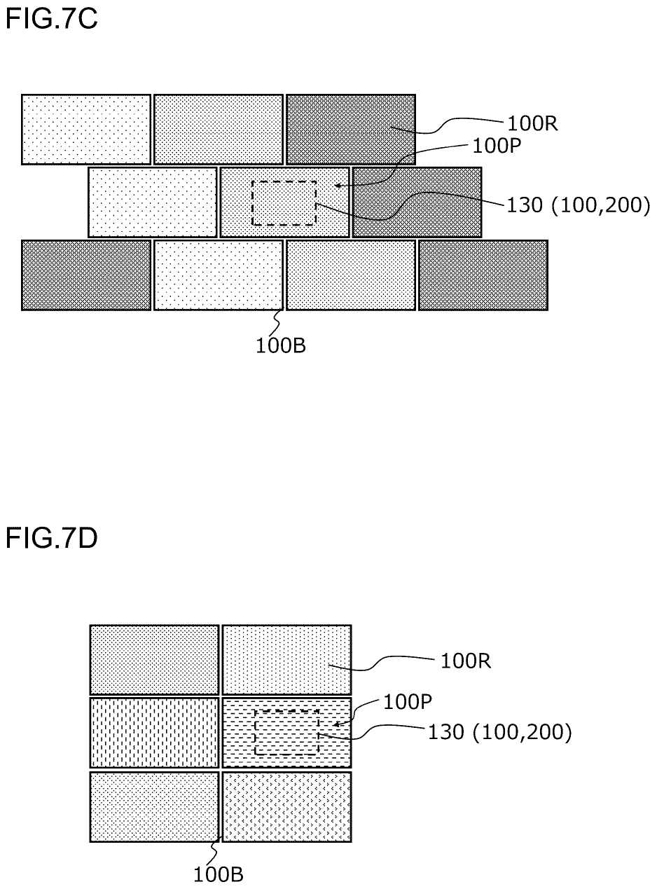

With reference to FIG. 7A to FIG. 7D, example decorations that may be added to the surface of the optical filter 130 and the surface of the surroundings of a place where the detection device 100 or the optical stack 200 is disposed will be described. FIG. 7A shows an example where a decoration of continuous patterning is added to the surface of the optical filter 130 and the surface of the surroundings 100P. In this example, a single patterning (decoration) is added to the surface of the surroundings 100P and the surface of the optical filter 130. This decoration may be realized by using a single decorative film. Therefore, there is no physical boundary in the film. The optical filter 130 is located at an arbitrary place on the single patterning, whereas the infrared light source 110 and the infrared sensor 120 included in the detection device 100 or the pattern on the storage medium layer 150 included in the optical stack 200 is hidden on the back side of the optical filter 130.

FIG. 7B shows an example where a decoration of tile-like patterning is added to the surface of the optical filter 130 and the surface of the surroundings 100P. The decoration of this example is a tile-like patterning that includes a graphic design, which may be realized by disposing a plurality of decorative films on a plane or a curved surface containing the surface of the optical filter 130 and the surface of the surroundings 100P. For this reason, physical film boundaries exist as joints between the films. Tile-like decorations include not only patternings that are created by a regular arrangement of an identical shape as shown in FIG. 7B, but also patternings that are created by an irregular arrangement of different shapes resulting in non-constant boundary widths. The optical filter 130 may be disposed along the boundaries, or astride the boundaries. The infrared light source 110 and the infrared sensor 120 included in the detection device 100 or the pattern on the storage medium layer 150 included in the optical stack 200 is hidden on the back side of the optical filter 130. In the example shown in FIG. 7B, the optical filter 130 is disposed astride boundaries within a patterning that is created by a regular arrangement of star shapes.

FIG. 7C shows another example where a decoration of tile-like patterning is added to the surface of the optical filter 130 and the surface of the surroundings 100P. The decoration of this example is a tile-like coloration including a combination of colors of the same hue but different chromas, which may be realized by disposing a plurality of decorative films on a plane or a curved surface containing the surface of the optical filter 130 and the surface of the surroundings 100P. For this reason, physical film boundaries exist as joints between the films. This decoration includes multiple regions 100R that are divided by visually recognizable boundaries 100B. The optical filter 130 is disposed in one of the multiple regions 100R. The infrared light source 110 and the infrared sensor 120 included in the detection device 100 or the pattern on the storage medium layer 150 included in the optical stack 200 is hidden on the back side of the optical filter 130. When there is a plurality of detection devices 100 or optical stacks 200, the plurality of optical filters 130 are disposed in respectively different ones of the multiple regions 100R. Each of the multiple regions 100R may have any arbitrary coloration or patterning.

FIG. 7D shows still another example where a decoration of tile-like patterning is added to the surface of the optical filter 130 and the surface of the surroundings 100P. This decoration includes multiple regions 100R that are divided by visually recognizable boundaries 100B, each multiple regions 100R having an arbitrary patterning. The optical filter 130 is disposed in one of the multiple regions 100R. The infrared light source 110 and the infrared sensor 120 included in the detection device 100 or the pattern on the storage medium layer 150 included in the optical stack 200 is hidden on the back side of the optical filter 130.

Thus, the color of the surroundings on which the detection device 100 or the optical stack 200 is disposed and the color of the surface of the optical filter 130 included in the detection device 100 or the optical stack 200 can be matched almost to an indistinguishable level. Let the color of a surface of the surroundings of a place where the detection device 100 or the optical stack 200 is disposed be called a surrounding color, and the color of a surface of the optical filter 130 be called a filter color; then, neither the surrounding color nor the filter color is black, and a color difference between the surrounding color and the filter color as measured by SCE method is 3 or smaller. Herein, the color difference being 3 or smaller means the conditions defined by the formula of eq. 1 being satisfied, where a₁* and b₁* are an a*value and a b*value of the surface of the surroundings in an L*a*b* color system, and a₂* and b₂* are an a*value and a b*value of the surface of the optical filter 130 in the L*a*b*color system.

$$\vert {a}_{1} ⋆ - {a}_{2} * \vert ≦ 3 , and \vert {b}_{1} * - {b}_{2} * \vert ≦ 3 \qquad [ eq . 1 ]$$

An example of an L*a*b* color system is the CIE1976 L*a*b* color system. From the standpoint of obtaining a better matching between the surrounding color and the filter color, the color difference is preferably 1.5 or smaller, and more preferably 0.4 or smaller. When the color difference is 3 or smaller, the surrounding color and the filter color can be matched almost to an indistinguishable level, whereby good decorative quality is exhibited.

### EXAMPLES

Hereinafter, the present invention will be specifically describe by way of Examples, but the present invention is not to be limited by these Examples. Herein, optical filters according to Comparative Examples and Examples are evaluated in terms of BRDF (bidirectional reflectance distribution function) and BTDF (bidirectional transmittance distribution function). First, measurement methods of BRDF and BTDF will be described. Next, for the optical filters according to Comparative Examples and Examples, results of taking BRDF and BTDF measurements with respect to visible light and infrared light will be described.

### [Measurement Methods of BRDF and BTDF]

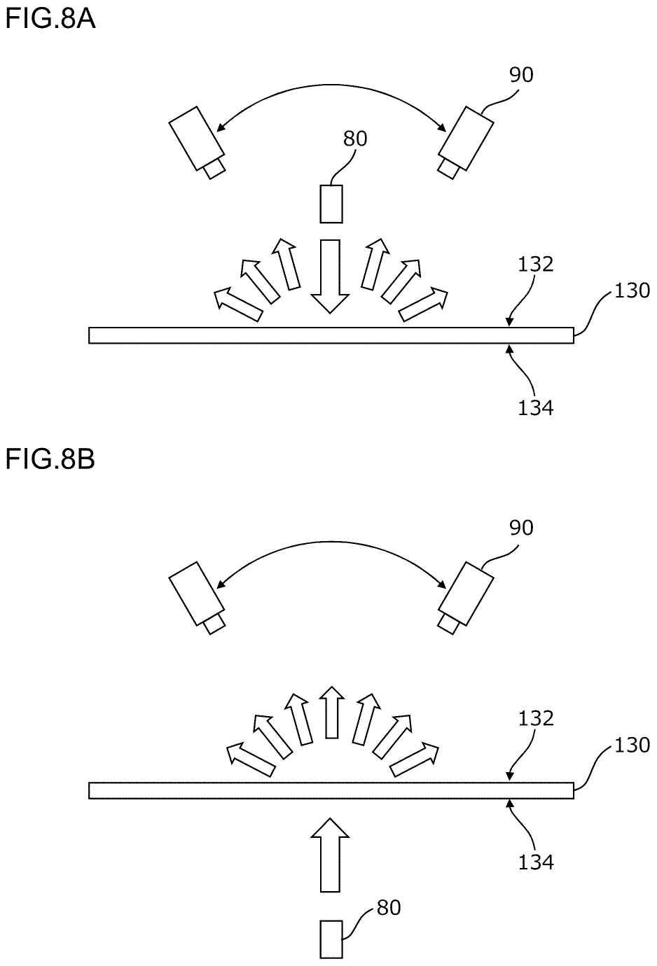

With reference to FIG. 8A and FIG. 8B, measurement methods of BRDF and BTDF will each be described. BRDF is a function of the intensity of reflected scattered light occurring as a result of irradiating an object with light, with respect to the reflection angle. BTDF is a function of the intensity of transmitted scattered light occurring as a result of irradiating an object with light, with respect to the transmission angle. The BRDF and BTDF measurements were taken with a Goniophotometer (manufactured by NIKKA DENSOK LIMITED, model No.: GP-4).

FIG. 8A shows a schematic cross-sectional view for describing a measurement method of BRDF. In the example shown in FIG. 8A, the light source 80 and the sensor 90 are disposed on the first principal face 132 of the optical filter 130. When the first principal face 132 of the optical filter 130 is perpendicularly irradiated with light emitted from the light source 80, reflected scattered light that occurs through the irradiation is detected by the sensor 90. Detection of the reflected scattered light is performed while moving the sensor 90 by every 1° in an angle range of not less than −30° and not more than 30°. This angle is an angle made by the normal of the first principal face 132 and the optical axis of a lens that is included in the sensor 90. When the sensor 90 overlaps the light source 80, no reflected scattered light is detected. In the following Examples and Comparative Examples, no BRDF was measured at angles which are not less than −5° and not more than 5°.

FIG. 8B shows a schematic cross-sectional view for describing a measurement method of BTDF. In the example shown in FIG. 8B, the light source 80 is disposed on the second principal face 134 of the optical filter 130, whereas the sensor 90 is disposed on the first principal face 132 of the optical filter 130. When the second principal face 134 of the optical filter 130 is perpendicularly irradiated with light emitted from the light source 80, transmitted scattered light that occurs through the irradiation is detected by the sensor 90. Detection of the transmitted scattered light is performed while moving the sensor 90 by every 1° in an angle range of not less than −30° and not more than 30°.

### [Structure of Optical Filters According to Comparative Examples and Examples]

First, the structure of Comparative Examples 1 to 4 will be described.

The optical filter of Comparative Example 1 includes: a base layer made of glass with a thickness of 3 mm; and an optical layer with a thickness of 1 mm that is disposed on the base layer. The optical layer corresponds to the optical filter of Example 6 (silica average particle size: 221 μm, silica content ratio: 40 mass %) in the aforementioned International Application.

The optical filter of Comparative Example 2 is a film made of NAFLON with a thickness of 0.2 mm (manufactured by AS ONE Corporation, model No.: NAFLON tape).

The optical filter of Comparative Example 3 is a film made of fluoroplastic with a thickness of 0.2 mm (manufactured by NITTO DENKO CORPORATION, model No.: NITOFLON).

The optical filter of Comparative Example 4 is a black film with a thickness of 0.5 mm (manufactured by Nitto Jushi, model No.: CLAREX).

Next, the structure of the optical filters of Examples 1 to 6 will be described. The optical filters of Examples 1 and 2 correspond to the optical filter 130 shown in FIG. 3A. The optical filters of Examples 3 to 6 correspond to the optical filter 130 shown in FIG. 3B.

In addition to the base layer and optical layer included in the optical filter of Comparative Example 1, the optical filter of Example 1 includes an anti-glare layer (manufactured by Daicel Corporation, model No.: PEN60) with a thickness of 60 μm that is disposed on the optical layer.

In addition to the base layer and optical layer included in the optical filter of Comparative Example 1, the optical filter of Example 2 includes the following layer that is disposed on the optical layer: a layer with a thickness of 30 μm that is made of a tackiness agent (manufactured by NITTO DENKO CORPORATION) whose haze value is adjusted to 80%.

Unlike the optical filter of Comparative Example 1, the optical filters of Examples 3 to 6 have a scattering plane in their optical layer. The scattering planes of the optical filters of Examples 3 to 6 are respectively realized by forming concavo-convex shapes having a surface roughness as shown in Table 1 on the surface of the optical layer that is included in the optical filter of Comparative Example 1.

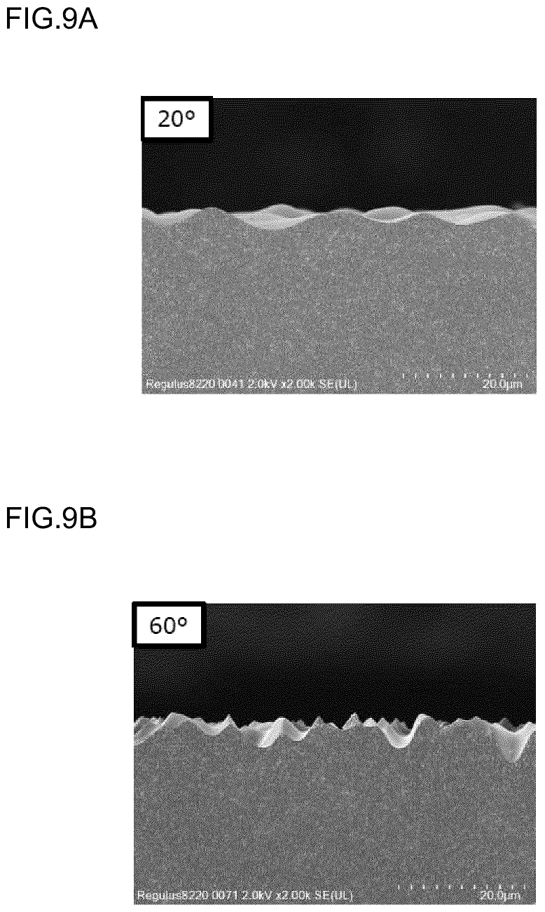

FIG. 9A and FIG. 9B respective show cross-sectional TEM images of the optical filters of Examples 3 and 6. As shown in FIG. 9A and FIG. 9B, the greater the diffusion angle of the lens diffusion plate is, the rougher the scattering plane is.

The mean roughness Ra and maximum height Rz of the scattering plane in Comparative Example 1 and the optical filters of Examples 3 and 6 are as shown in Table 1. The mean roughness Ra and maximum height Rz measurements were taken with a laser microscope VK-X1000 (manufactured by KEYENCE CORPORATION). The mean roughness Ra and the maximum height Rz were calculated based on results of measuring 1000×1000 points in an area spanning 2800 μm by 2800 μm with ×5 magnification.

TABLE 1

| | Ra (μm) | Rz (μm) |
|---|---|---|
| Comp. Ex. 1 | 0.286 | 13.45 |
| Ex. 3 | 1.785 | 20.53 |
| Ex. 4 | 1.199 | 15.40 |
| Ex. 5 | 1.241 | 21.02 |
| Ex. 6 | 1.198 | 16.97 |

The surface of the optical filter of Comparative Example 1 has a mean roughness Ra of 0.3 μm or less, and a maximum height Rz of 14 μm or less. On the other hand, the scattering planes of the optical filters of Examples 3 and 6 have a mean roughness Ra of 1 μm or more, and a maximum height Rz of 15 μm or more. Thus, the scattering planes of the optical filters of Examples 3 and 6 are rougher than the surface of the optical filter of Comparative Example 1.

Haze values of the optical filters of Comparative Examples 1 to 4 and the optical filters of Examples 1 to 6 with respect to infrared light are as shown in Table 2. Herein, a haze value with respect to infrared light is a mean value of haze values at wavelengths in the range of not less than 800 nm and not more than 2000 nm.

TABLE 2

| | Haze value |
|---|---|
| Comp. Ex. 1 | 2.00 |
| Comp. Ex. 2 | 44.4 |
| Comp. Ex. 3 | 32.4 |
| Comp. Ex. 4 | 2.6 |
| Ex. 1 | 62.9 |
| Ex. 2 | 43.1 |
| Ex. 3 | 88.3 |
| Ex. 4 | 89.3 |
| Ex. 5 | 94.6 |
| Ex. 6 | 96.3 |

The haze values of the optical filters of Comparative Examples 1 to 4 are 45% or less. On the other hand, the haze values of the optical filters of Examples 1 to 6 are 40% or more. The haze values of the optical filters of Examples 1 and 3 to 6 are 60% or more. The haze values of the optical filters of Examples 3 to 6 are 80% or more. The haze values of the optical filters of Examples 1 and 2 having a scattering layer are smaller than the haze values of the optical filters of Examples 3 to 6 having a scattering plane, but are sufficiently larger than the haze values of the optical filter of Comparative Example 1 lacking a scattering layer.

### [BRDF and BTDF of Optical Filters According to Comparative Examples and Examples]

Hereinafter, BRDF and BTDF of optical filters according to Comparative Examples and Examples with respect to visible light and infrared light will be described. Light of a wavelength of 550 nm will be discussed as visible light, and light of a wavelength of 850 nm will be discussed as infrared light. However, the wavelengths of visible light and infrared light to be incident on the optical filter are not limited to these wavelengths. BTDF will be described in logarithmic reading. The BRDF and BTDF in a case where visible light and infrared light enter at an incident angle of 0° are symmetrical left and right with respect to angle 0° as a reference point. Note that measurement errors may prevent any measurements of BRDF and BTDF from being symmetrical left and right with respect to angle 0° as a reference point.

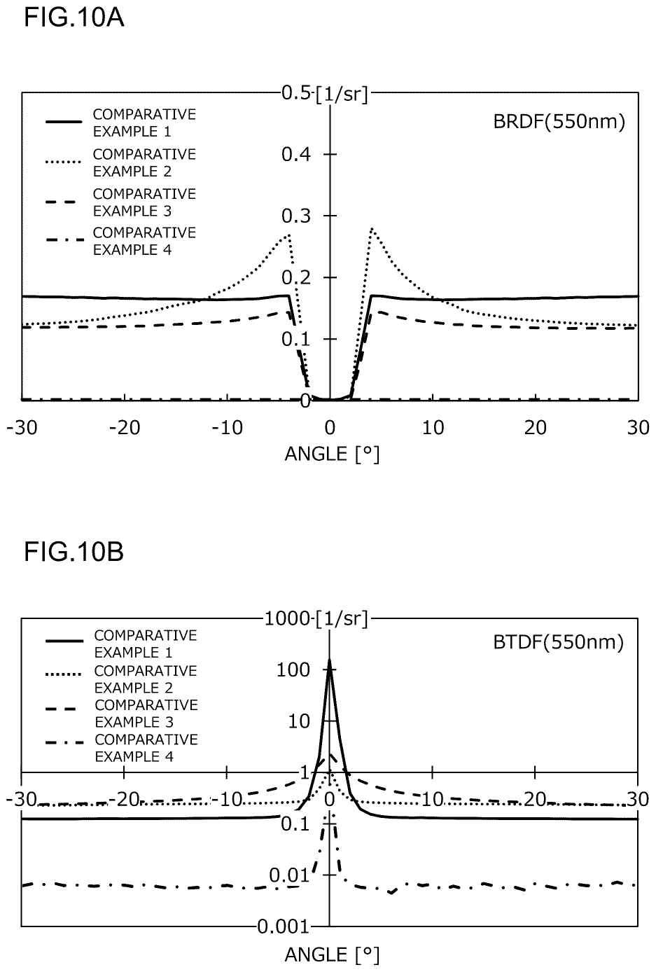

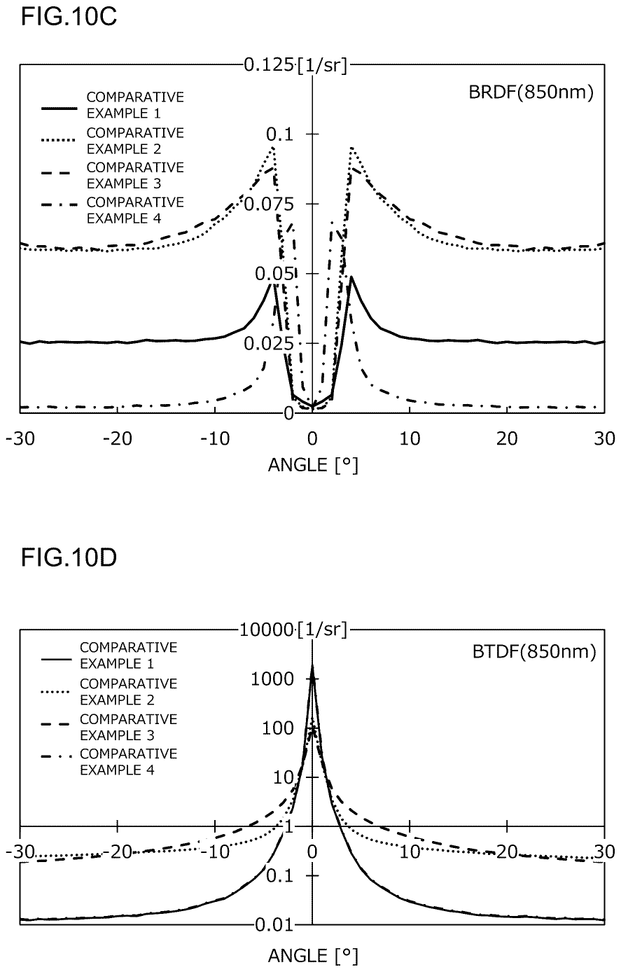

First, with reference to FIG. 10A to FIG. 10D, BRDF and BTDF of the optical filters of Comparative Examples 1 to 4 will be described.

FIG. 10A and FIG. 10B show BRDF and BTDF, respectively, of the optical filters of Comparative Examples 1 to 4 in a case where visible light with a wavelength of 550 nm enters at an incident angle of 0°. As shown in FIG. 10A, the BRDF of the optical filters of Comparative Examples 1 to 3 is 0.1 [1/sr] or greater at angles which are not less than −3° and not more than −5° and angles which are not less than 5° and not more than 3°. The BRDF of the optical filter of Comparative Example 4 is essentially zero at angles which are not less than −3° and not more than −5° and angles which are not less than 5° and not more than 3°. The reason is that the optical filter of Comparative Example 4 is a black film and absorbs visible light. As shown in FIG. 10B, the BTDF of the optical filter of Comparative Example 1 is 150 [1/sr] or greater near angle 0°. In other words, the optical filter of Comparative Example 1 shows high linear transmittance with respect to visible light. On the other hand, the BTDF of the optical filters of Comparative Examples 2 and 3 is 3 [1/sr] or smaller at angles which are not less than −30° and not more than 30°, whereas the BTDF of the optical filter of Comparative Example 4 is 0.2 [1/sr] or smaller at angles which are not less than −30° and not more than 30°. Therefore, the optical filters of Comparative Examples 1 to 3 effectively cause backward scatter of visible light, and the optical filters of Comparative Examples 2 and 3 effectively reduce transmission of visible light. The optical filter of Comparative Example 4 effectively absorbs visible light.

More detailed behavior of the BRDF of the optical filters of Comparative Examples 1 to 3 with respect to visible light with a wavelength of 550 nm is as follows. At angles which are not less than −30° and not more than −5° and angles which are not less than 5° and not more than 30°, the BRDF of the optical filters of Comparative Examples 1 and 3 is essentially constant at 0.1 [1/sr] or greater. The BRDF of the optical filter of Comparative Example 2 monotonically decreases as the angle goes from −5° to near −30° and as the angle goes from 5° to near 30°, but is 0.1 [1/sr] or greater.

FIG. 10C and FIG. 10D shows BRDF and BTDF, respectively, of the optical filters of Comparative Examples 1 to 4 in a case where infrared light with a wavelength of 850 nm enters at an incident angle of 0°. As shown in FIG. 10C, the BRDF of the optical filters of Comparative Examples 1 to 4 is 0.1 [1/sr] or smaller at angles which are not less than −30° and not more than −5° and angles which are not less than 5° and not more than 30°. As shown in FIG. 10D, the BTDF of the optical filters of Comparative Examples 1 to 4 shows a value as high as 100 [1/sr] or greater near angle 0°. In other words, the optical filters of Comparative Examples 1 to 4 shows high linear transmission with respect to infrared light. Logarithmic readings of the BTDF of the optical filters of Comparative Examples 1 to 4 monotonically decrease as the angle goes from 0° to near ±30°. Logarithmic readings of the BTDF of the optical filters of Comparative Examples 1 to 4 undergo convex downward changes at angles which are not less than −30° but less than 0° and angles which are more than 0° but not more than 30°. Thus, logarithmic readings of the BTDF of Comparative Examples 1 to 4 show a Lambertian distribution. Thus, the optical filters of Comparative Examples 1 to 4 effectively reduce reflection of infrared light, and effectively permit linear transmission of infrared light.

More detailed behavior of the BTDF of the optical filters of Comparative Examples 1 to 4 with respect to infrared light with a wavelength of 850 nm is as follows. The BTDF of the optical filters of Comparative Examples 1 and 4 is essentially the same. Logarithmic readings of the BTDF of the optical filters of Comparative Examples 1 and 4 monotonically undergo convex downward decreases as the angle goes from 0° to near ±30°, so that the BTDF becomes closer to 0.01 [1/sr]. On the other hand, logarithmic readings of the BTDF of the optical filters of Comparative Examples 2 and 3 monotonically undergo convex downward decreases as the angle goes from 0° to near ±30°, but the BTDF is 0.1 [1/sr] or greater.

The BTDF of the optical filters of Comparative Examples 1 to 4 can be defined by (a value at −1°)/(a value at −1°) and (a value at 1°)/(a value at 1°). The higher the values of (a value at −1°)/(a value at −1°) and (a value at 1°)/(a value at 10°) are, the greater the linear transmittance of infrared light is. Let the BTDF value at −1° be called an A value, the BTDF value at −10° a B value, the BTDF value at 1° a C value, and the BTDF value at 10° a D value; then, the A value, the B value, the C value, the D value, the A value/B value, and the C value/D value in the BTDF of the optical filters of Comparative Examples 1 to 4 are as shown in Table 3. The A value/B value corresponds to (a value at −1°)/(a value at −10°), whereas the C value/D value corresponds to (a value at 1°)/(a value at 10°).

TABLE 3

| | | | | | A value/ | C value/ |
|---|---|---|---|---|---|---|
| | A value | B value | C value | D value | B value | D value |
| Comp. Ex. 1 | 17.31 | 0.03012 | 26.50 | 0.02943 | 574.9 | 900.3 |
| Comp. Ex. 2 | 16.90 | 0.3803 | 18.71 | 0.3768 | 44.43 | 49.64 |
| Comp. Ex. 3 | 17.93 | 0.5776 | 19.03 | 0.6159 | 31.04 | 30.90 |
| Comp. Ex. 4 | 17.66 | 0.03072 | 27.03 | 0.03002 | 574.9 | 900.3 |

In the BTDF of the optical filters of Comparative Examples 1 to 4, (a value at −1°)/(a value at −10°) and (a value at 1°)/(a value at 10°) are greater than 30. The optical filters of Comparative Examples are as follows. In the BTDF of the optical filter of Comparative Example 3, (a value at −1°)/(a value at −10°) and (a value at 1°)/(a value at 10°) are greater than 30. In the BTDF of the optical filter of Comparative Example 2, (a value at −1°)/(a value at −10°) and (a value at 1°)/(a value at 10°) are greater than 40. In the BTDF of the optical filters of Comparative Examples 1 and 4, (a value at −1°)/(a value at −10°) and (a value at 1°)/(a value at 10°) are greater than 500.

From the above, the optical filters of Comparative Examples 1 to 3 effectively cause backward scatter of visible light, and effectively permit linear transmission of infrared light. The optical filter of Comparative Example 4 effectively absorbs visible light, and effectively permits linear transmission of infrared light.

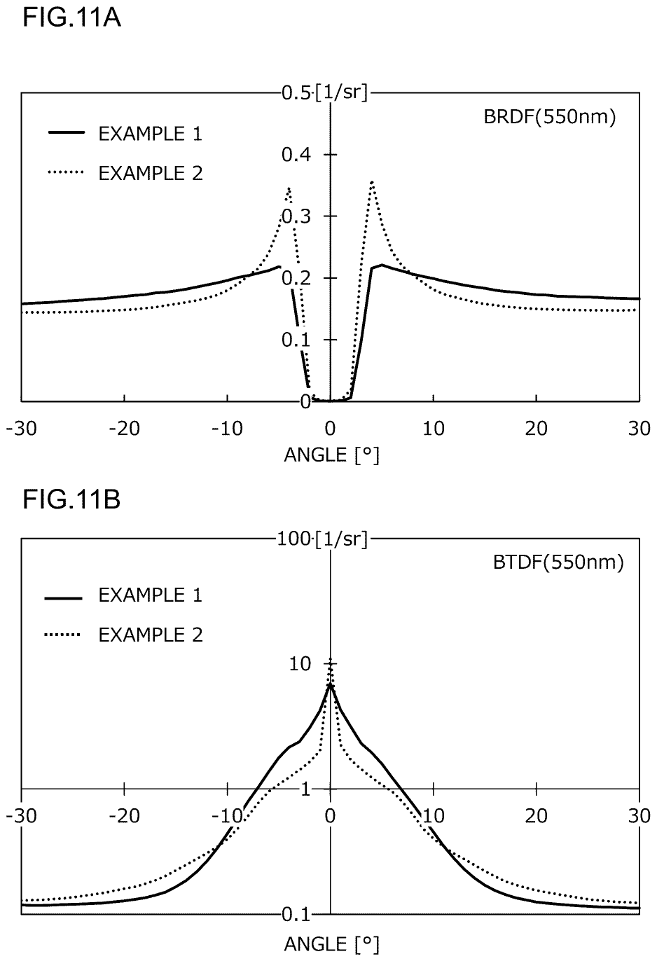

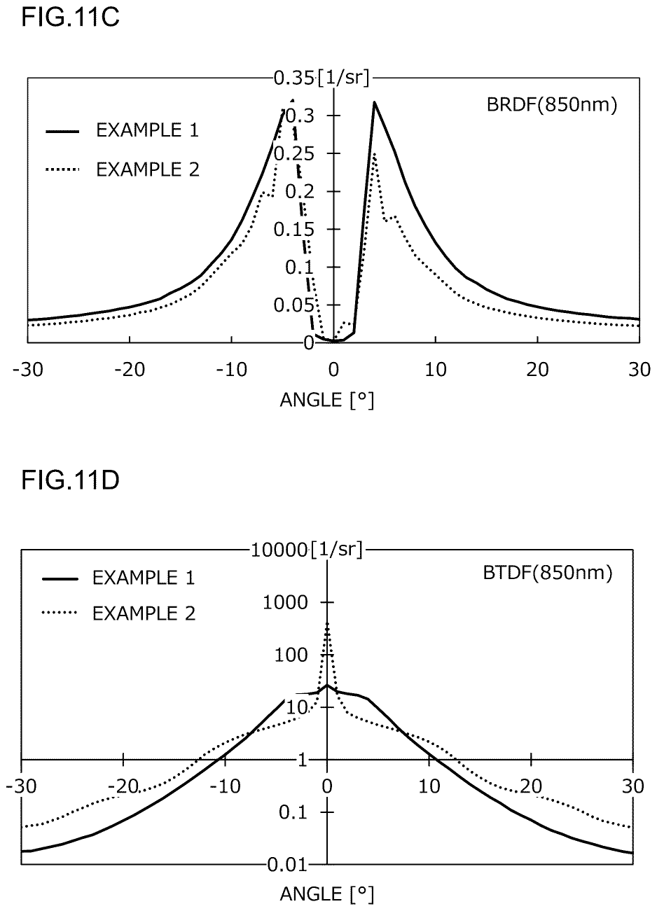

Next, with reference to FIG. 11A to FIG. 11D, BRDF and BTDF of the optical filters of Examples 1 and 2 will be described.

FIG. 11A and FIG. 11B show BRDF and BTDF, respectively, of the optical filters of Examples 1 and 2 in a case where visible light with a wavelength of 550 nm enters at an incident angle of 0°. As shown in FIG. 11A, the BRDF of the optical filters of Examples 1 and 2 is 0.1 [1/sr] or greater at angles which are not less than −30° and not more than −5° and angles which are not less than 5° and not more than 30°. As shown in FIG. 11B, the BTDF of the optical filters of Examples 1 and 2 is 12 [1/sr] or smaller at angles which are not less than −30° and not more than 30°. Therefore, the optical filters of Examples 1 and 2 effectively cause backward scatter of visible light, and effectively reduce transmission of visible light.

More detailed behavior of the BRDF of the optical filters of Examples 1 and 2 with respect to visible light with a wavelength of 550 nm is as follows. The BRDF of the optical filters of Examples 1 and 2 having a scattering layer is greater than the BRDF of the optical filter of Comparative Example 1 lacking a scattering layer at angles which are not less than −10° and not more than −5° and angles which are not less than and 5° and not more than 10°. From this, it can be seen that the scattering layer included in the optical filters of Examples 1 and 2 increases backward scatter of visible light.

FIG. 11C and FIG. 11D show BRDF and BTDF, respectively, of the optical filters of Examples 1 and 2 in a case where infrared light with a wavelength of 850 nm enters at an incident angle of 0°. As shown in FIG. 11C, the BRDF of the optical filters of Examples 1 and 2 is 0.35 [1/sr] or smaller at angles which are not less than −30° and not more than −5° and angles which are not less than 5° and not more than 30°, and more specifically 0.1 [1/sr] or smaller, at angles which are not less than −30° and not more than −15° and angles which are not less than 15° and not more than 30°. As shown in FIG. 11D, the BTDF of the optical filter of Example 2 shows a value as high as 100 [1/sr] or greater near angle 0°, whereas the BTDF of the optical filter of Example 1 is 50 [1/sr] or smaller, and more specifically 30 [1/sr] or smaller, at angles near angle 0° which are not less than −5° and not more than 5°. Logarithmic readings of the BTDF of the optical filters of Examples 1 and 2 monotonically decrease as the angle goes from 0° to near ±30°. Logarithmic readings of the BTDF of the optical filters of Examples 1 and 2 have a portion undergoing convex upward changes at angles which are not less than −30° and not more than −2° and angles which are not less than 2° and not more than 30°. The optical filters of Examples are as follows. Logarithmic readings of the BTDF of the optical filter of Example 1 have a portion undergoing convex upward changes at angles which are not less than −10° and not more than −2° and angles which are not less than 2° and not more than 10°. Logarithmic readings of the BTDF of the optical filter of Example 2 have a portion undergoing convex upward changes at angles which are not less than −15° and not more than −5° and angles which are not less than 5° and not more than 15°. Thus, logarithmic readings of the BTDF of Examples 1 and 2 show a non-Lambertian distribution. A portion undergoing convex upward changes is indicative of increasing forward scatter. Therefore, the optical filters of Examples 1 and 2 effectively reduce reflection of infrared light, and effectively cause forward scatter of infrared light.

More detailed behavior of the BTDF of the optical filters of Examples 1 and 2 with respect to infrared light with a wavelength of 850 nm is as follows. The BTDF of the optical filters of Examples 1 and 2 having a scattering layer is greater than the BTDF of the optical filter of Comparative Example 1 lacking a scattering layer at angles which are not less than −30° but less than −2° and angles which are more than 2° but not more than 30°. From this, it can be seen that the scattering layer included in the optical filters of Examples 1 and 2 increases forward scatter of infrared light.

The BTDF of the optical filters of Examples 1 and 2 that cause forward scatter of infrared light can be defined by (a value at −1°)/(a value at −10°) and (a value at 1°)/(a value at 10°). The smaller the values of (a value at −1°)/(a value at −10°) and (a value at 1°)/(a value at 10°) are, the greater the forward scatter of infrared light is. In the BTDF of the optical filters of Examples 1 and 2, the A value, the B value, the C value, the D value, the A value/B value, and the C value/D value are as shown in Table 4.

TABLE 4

| | | | | | A value/ | C value/ |
|---|---|---|---|---|---|---|
| | A value | B value | C value | D value | B value | D value |
| Ex. 1 | 19.08 | 1.251 | 19.84 | 1.282 | 15.26 | 15.48 |
| Ex. 2 | 12.79 | 2.111 | 16.46 | 2.181 | 6.058 | 7.546 |

In the BTDF of the optical filters of Examples 1 and 2, (a value at −1°)/(a value at −10°) and (a value at 1°)/(a value at 10°) are 20 or smaller. The optical filters of Examples are as follows. In the BTDF of the optical filter of Example 1, (a value at −1°)/(a value at −10°) and (a value at 1°)/(a value at 10°) are 20 or smaller, and more specifically, 16 or smaller. In the BTDF of the optical filter of Example 2, (a value at −1°)/(a value at −10°) and (a value at 1°)/(a value at 10°) are 10 or smaller, and more specifically, 8 or smaller. In the BTDF of the optical filters of Examples 1 and 2, (a value at −1°)/(a value at −10°) and (a value at 1°)/(a value at 10°) are smaller than (a value at −1°)/(a value at −1°) and (a value at 1°)/(a value at 1°) in the BTDF of the optical filters of Comparative Examples 1 to 4.

From the above, the optical filters of Examples 1 and 2 effectively cause backward scatter of visible light, and effectively cause forward scatter of infrared light.

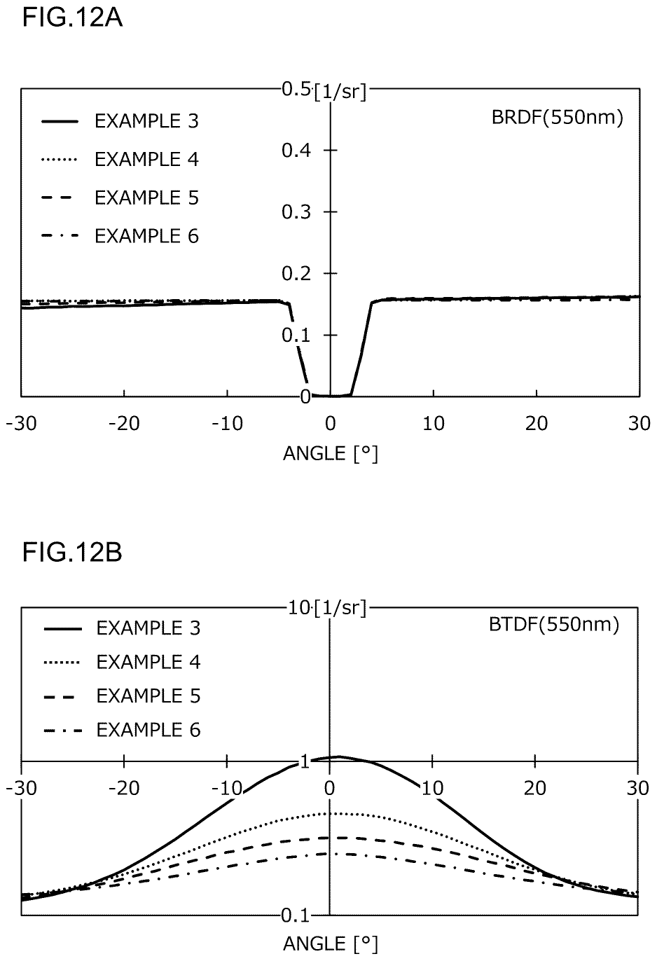

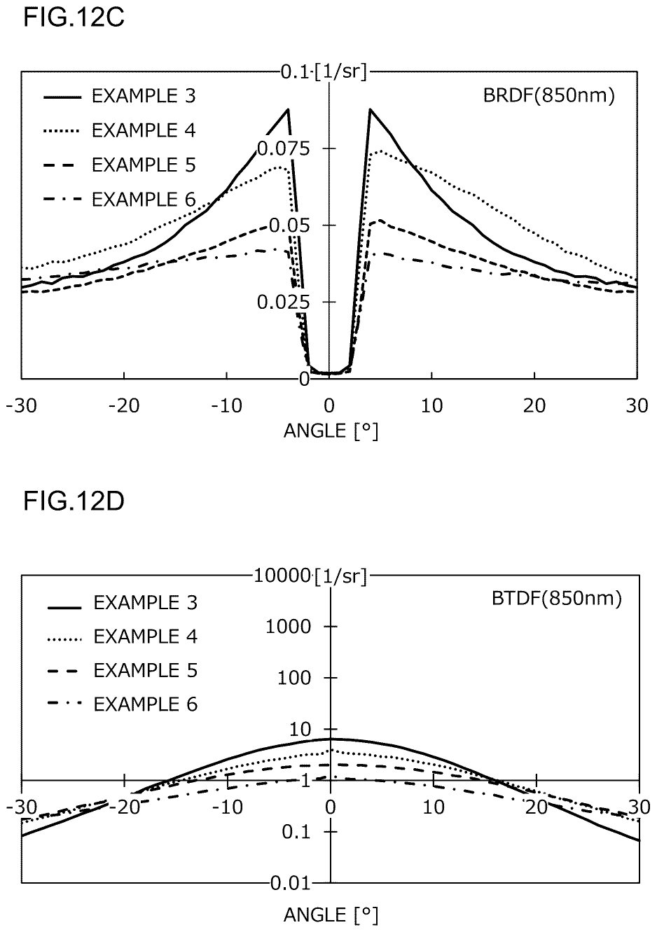

Next, with reference to FIG. 12A to FIG. 12D, BRDF and BTDF of the optical filters of Examples 3 to 6 will be described.

FIG. 12A and FIG. 12B show BRDF and BTDF, respectively, of the optical filters of Examples 3 to 6 in a case where visible light with a wavelength of 550 nm enters at an incident angle of 0°. As shown in FIG. 12A, the BRDF of the optical filters of Examples 3 to 6 is essentially the same, and is 0.1 [1/sr] or greater at angles which are not less than −30° and not more than −5° and angles which are not less than 5° and not more than 30°. As shown in FIG. 12B, the BTDF of the optical filters of Examples 3 to 6 is 2 [1/sr] or smaller at angles which are not less than −30° and not more than 30°. Therefore, the optical filters of Examples 3 to 6 effectively cause backward scatter of visible light, and effectively reduce transmission of visible light.

More detailed behavior of the BRDF of the optical filters of Examples 3 to 6 with respect to visible light with a wavelength of 550 nm is as follows. The BRDF of the optical filters of Examples 3 to 6 having a scattering plane in their optical layer is essentially the same as the BRDF of the optical filter of Comparative Example 1 not having a scattering plane in its optical layer optical layer. From this, it can be seen that the scattering plane of the optical layer included in the optical filters of Examples 3 to 6 hardly affects backward scatter of visible light.

FIG. 12C and FIG. 12D show BRDF and BTDF, respectively, of the optical filters of Examples 3 to 6 in a case where infrared light with a wavelength of 850 nm enters at an incident angle of 0°. As shown in FIG. 12C, the BRDF of the optical filters of Examples 3 to 6 is 0.1 [1/sr] or smaller at angles which are not less than −30° and not more than −5° and angles which are not less than 5° and not more than 30°. As shown in FIG. 12D, the BTDF of the optical filters of Examples 3 to 6 is 10 [1/sr] or smaller at angles near angle 0° which are not less than −5° and not more than 5°. Logarithmic readings of the BTDF of the optical filters of Examples 3 to 6 monotonically decrease as the angle goes from 0° to near ±30°. Logarithmic readings of the BTDF of the optical filters of Examples 3 to 6 have a portion undergoing convex upward changes at angles which are not less than −30° and not more than −2° and angles which are not less than 2° and not more than 30°. Thus, logarithmic readings of the BTDF of Examples 3 to 6 show a non-Lambertian distribution. As mentioned above, a portion undergoing convex upward changes is indicative of increasing forward scatter. Therefore, the optical filters of Examples 3 to 6 effectively reduce reflection of infrared light, and effectively cause forward scatter of infrared light.

More detailed behavior of the BTDF of the optical filters of Examples 3 to 6 with respect to infrared light with a wavelength of 850 nm is as follows. The BTDF of the optical filters of Examples 3 to 6 having a scattering plane in their optical layer is greater than the BTDF of the optical filter of Comparative Example 1 not having a scattering plane in its optical layer optical layer at angles which are not less than −30° but less than −2° and angles which are more than 2° but not more than 30°. The BTDF near angle 0° decreases as the diffusion angle of the lens diffusion plate increases. From this, it can be seen that the scattering plane of the optical layer included in the optical filters of Examples 3 to 6 increases forward scatter of infrared light.

Similarly to the BTDF of the optical filters of Examples 1 and 2, the BTDF of the optical filters of Examples 3 to 6 that cause forward scatter of infrared light can be defined by (a value at −1°)/(a value at −10°) and (a value at 1°)/(a value at 10°). In the BTDF of the optical filters of Examples 3 to 6 the A value, the B value, the C value, the D value, the A value/B value, and the C value/D value are as shown in Table 5.

TABLE 5

| | | | | | A value/ | C value/ |
|---|---|---|---|---|---|---|
| | A value | B value | C value | D value | B value | D value |
| Ex. 3 | 1.040 | 0.5347 | 1.069 | 0.6127 | 1.946 | 1.745 |
| Ex. 4 | 0.4539 | 0.3212 | 0.4569 | 0.3484 | 1.413 | 1.311 |
| Ex. 5 | 0.3164 | 0.2559 | 0.3181 | 0.2718 | 1.236 | 1.170 |
| Ex. 6 | 0.2491 | 0.2063 | 0.2496 | 0.2143 | 1.207 | 1.164 |

In the BTDF of the optical filters of Examples 3 to 6, (a value at −1°)/(a value at −10°) and (a value at 1°)/(a value at 10°) are 5 or smaller, and more specifically, 2 or smaller. The BTDF of the optical filters of Examples 3 to 6, (a value at −1°)/(a value at −10°) and (a value at 1°)/(a value at 10°) are sufficiently smaller than (a value at −1°)/(a value at −10°) and (a value at 1°)/(a value at 10°) in the BTDF of the optical filters of Comparative Examples 1 to 4.

From the above, the optical filters of Examples 3 to 6 effectively cause backward scatter of visible light, and effectively cause forward scatter of infrared light.

Results which have been found from the BRDF and BTDF of the optical filters of Examples 1 to 6 with respect to visible light and infrared light are summarized below.

Regarding the optical filters of Examples 1 to 6, the BRDF (bidirectional reflectance distribution function) in a case where visible light with a wavelength of 550 nm enters at an incident angle of 0° is 0.1 [1/sr] or greater at angles which are not less than −30° and not more than −5° and angles which are not less than 5° and not more than 3°. Therefore, the optical filters of Examples 1 to 6 can effectively cause backward scatter of visible light. This makes it possible to reduce heating that results from absorption of visible light.

Regarding the optical filters of Examples 1 to 6, logarithmic readings of the BTDF in a case where infrared light with a wavelength of 850 nm enters at an incident angle of 0° have a portion undergoing convex upward changes at angles which are not less than −30° and not more than −2° and angles which are not less than 2° and not more than 30°. Therefore, the optical filters of Examples 1 to 6 can effectively cause forward scatter of infrared light. This makes it possible to reduce the glare associated with detecting an object with infrared light.

In the BTDF of the optical filters of Examples 1 to 6 in a case where infrared light with a wavelength of 850 nm enters at an incident angle of 0°, (a value at −1°)/(a value at −10°) and (a value at 1°)/(a value at 10°) are 20 or smaller. The optical filters of Examples are as follows. In the BTDF of the optical filter of Example 1, (a value at −1°)/(a value at −10°) and (a value at 1°)/(a value at 10°) are 20 or smaller. In the BTDF of the optical filter of Example 2, (a value at −1°)/(a value at −10°) and (a value at 1°)/(a value at 10°) are 10 or smaller. In the BTDF of the optical filters of Examples 3 to 6, (a value at −1°)/(a value at −10°) and (a value at 1°)/(a value at 10°) are 5 or smaller.

In the BTDF of the optical filters of Comparative Examples 1 to 4 in a case where infrared light with a wavelength of 850 nm enters at an incident angle of 0°, (a value at −1°)/(a value at −10°) and (a value at 1°)/(a value at 10°) are greater than 30. Therefore, in the BTDF of an optical filter in a case where infrared light with a wavelength of 850 nm enters at an incident angle of 0°, when (a value at −1°)/(a value at −10°) and (a value at 1°)/(a value at 10°) are 30 or smaller, the optical filter can more effectively cause forward scatter of infrared light than the optical filters of Comparative Examples 1 to 4. When (a value at −1°)/(a value at −1°) and (a value at 1°)/(a value at 1°) are 25 or smaller, the optical filter can more effectively cause forward scatter of infrared light. When (a value at −1°)/(a value at −1°) and (a value at 1°)/(a value at 1°) are 20 or smaller, the optical filter can even more effectively cause forward scatter of infrared light.

Regarding the optical filters of Examples 1 and 3 to 6, the BTDF in a case where infrared light with a wavelength of 850 nm enters at an incident angle of 0° is 50 [1/sr] or smaller at angles which are not less than −5° and not more than 5°. In particular, regarding the optical filters of Examples 3 to 6, the BTDF in a case where infrared light with a wavelength of 850 nm enters at an incident angle of 0° is 10 [1/sr] or smaller at angles which are not less than −5° and not more than 5°. Therefore, the optical filters of Examples 1 and 3 to 6 can more effectively reduce linear transmission of infrared light, thereby making it possible to more effectively reduce the glare associated with detecting an object with infrared light. In particular, the optical filters of Examples 3 to 6 can more effectively reduce linear transmission infrared light, thereby making it possible to more effectively reduce the glare associated with detecting an object with infrared light.

[Linear Transmittance and Diffuse Transmittance of Optical Filters According to Comparative Examples and Examples, with Respect to Visible Light]

Linear transmittance, diffuse transmittance, and total transmittance of the optical filters of Comparative Examples 1 to 4 and the optical filters of Examples 1 to 6 with respect to visible light are as shown in Table 6 below. Herein, a linear transmittance, a diffuse transmittance, and a total transmittance with respect to visible light are, respectively, a mean value of linear transmittances, diffuse transmittances, and total transmittances at wavelengths of not less than 380 nm and not more than 780 nm.

TABLE 6

| | linear | diffuse | total |
|---|---|---|---|
| | transmittance | transmittance | transmittance |
| | (%) | (%) | (%) |
| Comp. Ex. 1 | 18.12 | 32.12 | 50.24 |
| Comp. Ex. 2 | 2.967 | 50.56 | 53.53 |
| Comp. Ex. 3 | 1.837 | 49.92 | 51.76 |
| Comp. Ex. 4 | 9.548 | 2.216 | 11.76 |
| Ex. 1 | 5.112 | 41.27 | 46.38 |
| Ex. 2 | 4.026 | 45.00 | 49.03 |
| Ex. 3 | 2.172 | 41.44 | 43.61 |
| Ex. 4 | 1.562 | 45.85 | 47.41 |
| Ex. 5 | 1.219 | 50.29 | 51.51 |
| Ex. 6 | 1.922 | 48.18 | 50.10 |

Linear transmittance was evaluated as follows. Linear transmittance is a transmittance as measured with the optical stack being disposed at a certain distance (e.g., 20 cm) away from the aperture of an integrating sphere. As a spectroscope, UV-Vis-NIR Spectrophotometer UH4150 (manufactured by Hitachi High-Tech Corporation) was used. Diffuse transmittance was evaluated as follows. Diffuse transmittance was derived based on a difference between total light transmittance and linear transmittance. Total light transmittance is a transmittance as measured with the optical stack being disposed at the aperture of an integrating sphere.

As shown in Table 6, the linear transmittance of the optical filter of Comparative Example 1 is 15% or more. On the other hand, the linear transmittance of the optical filters of Comparative Examples 2 to 4 and Examples 1 to 4 is 10% or less. The diffuse transmittance of the optical filters of Comparative Examples 1 to 4 and Examples 1 to 4 is 51% or less. The total transmittance of the optical filters of Comparative Examples 1 to 4 and Examples 1 to 4 is 54% or less.

From this, it can be seen that the optical filters of Comparative Examples 2 to 4 and Examples 1 to 4 effectively reduce linear transmission of visible light because they have a linear transmittance of 10% or less, and that the optical filters of Comparative Examples 1 to 3 and Examples 1 to 4 do not so effectively transmit visible light because they have a total transmittance of 54% or less.

[Linear Transmittance and Diffuse Transmittance of Optical Filters According to Comparative Examples and Examples with Respect to Infrared Light]

Linear transmittance, diffuse transmittance, and total transmittance of the optical filters of Comparative Examples 1 to 4 and the optical filters of Examples 1 to 6 with respect to infrared light are as shown in Table 7 below. Herein, a linear transmittance, a diffuse transmittance, and a total transmittance with respect to infrared light are, respectively, a mean value of linear transmittances, diffuse transmittances, and total transmittances at wavelengths in the range of not less than 800 nm and not more than 2000 nm.

TABLE 7

| | linear | diffuse | total |
|---|---|---|---|
| | transmittance | transmittance | transmittance |
| | (%) | (%) | (%) |
| Comp. Ex. 1 | 86.03 | 1.718 | 87.75 |
| Comp. Ex. 2 | 43.44 | 34.69 | 78.13 |
| Comp. Ex. 3 | 51.65 | 24.81 | 76.46 |
| Comp. Ex. 4 | 81.65 | 2.185 | 83.84 |
| Ex. 1 | 31.35 | 53.20 | 84.55 |
| Ex. 2 | 47.91 | 36.23 | 84.14 |
| Ex. 3 | 10.28 | 77.32 | 87.60 |
| Ex. 4 | 9.451 | 78.88 | 88.33 |
| Ex. 5 | 4.818 | 84.32 | 89.14 |
| Ex. 6 | 3.335 | 86.32 | 89.66 |

As shown in Table 7, the linear transmittance of the optical filters of Comparative Examples 1 to 4 is 40% or more. On the other hand, the optical filters of Examples 1 and 3 to 6 have a linear transmittance of 35% or less. The optical filters of Examples 3 to 6 have a linear transmittance of 15% or less, and more specifically, 11% or less. From this, too, it can be seen that the optical filters of Examples 1 and 3 to 6 can more effectively reduce linear transmission of infrared light than the optical filters of Comparative Examples 1 to 4, and that the optical filters of Examples 3 to 6, in particular, can more effectively reduce linear transmission of infrared light.

As shown in Table 7, the diffuse transmittance of the optical filters of Comparative Examples 1 to 4 is less than 35%. In particular, the diffuse transmittance of the optical filters of Comparative Examples 1 and 4 is 5% or less. On the other hand, the optical filters of Examples 1 to 6 have a diffuse transmittance of 35% or more. The optical filters of Examples 1 and 3 to 6 have a diffuse transmittance of 53% or more. In particular, the optical filters of Examples 3 to 6 have a diffuse transmittance of 70% or more. The optical filters of Examples 1 and 2 having a scattering layer have a lower diffuse transmittance than do the optical filters of Examples 3 to 6 having a scattering plane, but a higher diffuse transmittance than does the optical filter of Comparative Example 1 lacking a scattering layer. From this, too, it can be seen that, the optical filters of Examples 1 to 6 can more effectively increase forward scatter of infrared light than the optical filters of Comparative Examples 1 to 4, and that the optical filters of Examples 3 to 6 can more effectively increase forward scatter of infrared light, in particular.

Note that, as shown in Table 7, the total transmittance of the optical filters of Comparative Examples 1 to 4 and Examples 1 to 6 is 75% or more. Thus, it can be seen that, when linear transmittance and diffuse transmittance are included, the optical filters of Comparative Examples 1 to 4 and Examples 1 to 6 effectively transmit infrared light.

### REFERENCE SIGNS LIST

10: object 12: matrix 14: microparticles 100: detection device 100B: boundary 100P: surroundings 100R: region 110: infrared light source 120: infrared sensor 130: optical filter 130A: optical layer 130B: scattering layer 130C: base layer 130D: optical layer 130E: decorative layer 130F: surface protection layer 132: first principal face 132D: scattering plane 134: second principal face 140: housing 142: opening 150: storage medium layer 200: optical stack

1. An optical filter wherein,
a BRDF (bidirectional reflectance distribution function) in a case where visible light with a wavelength of 550 nm enters at an incident angle of 0° is 0.1 [1/sr] or greater at angles which are not less than −30° and not more than −5° and angles which are not less than 5° and not more than 30°; and,
in a BTDF (bidirectional transmittance distribution function) in a case where infrared light with a wavelength of 850 nm enters at an incident angle of 0°, (a value at −1°)/(a value at −10°) and (a value at 1°)/(a value at 10°) are 30 or smaller; the optical filter comprising:
an optical layer that causes backward scatter of the visible light and permits linear transmission of the infrared light; and
a scattering layer that causes forward scatter of the infrared light, the scattering layer being disposed on the optical layer directly or via another layer.

2. The optical filter of claim 1, wherein (a value at −1°)/(a value at −10°) and (a value at 1°)/(a value at 10°) are 25 or smaller.

3. The optical filter of claim 1, wherein the BTDF is 50 [1/sr] or smaller at angles which are not less than −5° and not more than 5°.

4. The optical filter of claim 1, wherein a mean value of diffuse transmittances at wavelengths in a range of not less than 800 nm and not more than 2000 nm is 35% or more.

5. (canceled)

6. (canceled)

7. (canceled)

8. The optical filter of claim 1, wherein a mean value of haze values of the optical filter at wavelengths in a range of not less than 800 nm and not more than 2000 nm is 40% or more.

9. The optical filter of claim 1, wherein as measured by SCE (Specular Component Excluded) method using a spectrocolorimeter, the optical layer has an L* value of 20 or greater.

10. The optical filter of claim 1, wherein the optical layer comprises a matrix and microparticles dispersed in the matrix to serve as light-scattering bodies.

11. The optical filter of claim 10, wherein the microparticles create at least a colloidal amorphous aggregate.

12. The optical filter of claim 11, wherein a transmittance curve of a visible light wavelength region of the optical layer has a curved segment in which linear transmittance monotonically decreases from longer wavelengths toward shorter wavelengths, the curved segment shifting toward longer wavelengths with an increasing incident angle.

13. A detection device that detects an object, the detection device comprising:
an infrared light source to emit infrared light with which to irradiate the object;
an infrared sensor to detect infrared light that is reflected from the object; and
the optical filter of claim 1, the optical filter being disposed so as to lie across the infrared light emitted from the infrared light source.

14. An optical stack comprising:
the optical filter of claim 1, the optical filter having a first principal face and a second principal face on an opposite side from the first principal face; and
a storage medium layer being disposed on the second principal face side of the optical filter and having a pattern that is readable with the infrared light through the optical filter.
